(19) United States
(12) Patent Application Publication
(10) Pub. No.: US 2026/0034983 A1
(43) Pub. Date: Feb. 5, 2026

(54) TRAJECTORY PLANNING UTILIZING A STATEFUL PLANNER AND A STATELESS PLANNER

(71) Applicant: Motional AD LLC, Boston, MA (US)

(72) Inventor: Momchil Tomov, Cambridge, MA (US)

(21) Appl. No.: 19/356,398

(22) Filed: Oct. 13, 2025

Related U.S. Application Data
(63) Continuation of application No. PCT/US2023/018733, filed on Apr. 14, 2023.

(51) Int. Cl. B60W 30/09; B60W 60/00; G01C 21/34

(52) U.S. Cl. CPC B60W 30/09; G01C 21/3415; B60W 60/0011; B60W 2420/403; B60W 2420/408; B60W 2554/4026; B60W 2554/4029

(57) ABSTRACT

Provided are methods for trajectory generation using an adjusted plurality of trajectories, which can include generating a plurality of trajectories for a vehicle from a plurality of poses, combinations of trajectories of the plurality of trajectories representing a plurality of paths for the vehicle through an environment, adjusting the plurality of trajectories to obtain an adjusted plurality of trajectories based on component data associated with the vehicle, selecting a first trajectory from the adjusted plurality of trajectories, and determining a path for the vehicle to operate along based on the first trajectory. Systems and computer program products are also provided.

### RELATED APPLICATIONS

This application is a continuation of PCT Patent Application No. PCT/US2023/018733, filed on Apr. 14, 2023, entitled “TRAJECTORY PLANNING UTILIZING A STATEFUL PLANNER AND A STATELESS PLANNER,” which is incorporated herein by reference in its entirety.

### BACKGROUND

Self-driving vehicles typically use many decisions during operation. Executing the decisions can be difficult and complicated due to potential driving requirements enforced by traffic laws, cultural expectations, safety considerations, driving norms, etc. as well as their relative priorities.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 are diagrams of an implementation of a process for graph exploration for trajectory generation based on a hierarchical plurality of rules;

FIG. 6 illustrates an example scenario for autonomous vehicle operation using graph exploration with behavioral rule checks;

FIG. 7 illustrates an example flow diagram of a process for vehicle operation using behavioral rule checks to determine a fixed set of trajectories;

FIG. 8 is an illustration of iteratively growing graphs to find a trajectory after-the-fact;

FIG. 9 is a diagram of system that calculates priorities according to a hierarchical plurality of rules;

FIG. 10 is a flowchart of a process for graph exploration for trajectory generation.

FIG. 11 is a block diagram illustrating an example of a signal processing system;

FIG. 12 is an example environment in which a vehicle including one or more components of an autonomous system can be implemented;

FIG. 13A is a flow diagram illustrating an example identification of a plurality of trajectories for a vehicle;

FIG. 13B is a flow diagram illustrating an example identification of a path for a vehicle;

FIG. 14 is a flow diagram illustrating an example of a routine implemented by one or more processors to determine a path for a vehicle.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a signal processing system that selects a trajectory for a vehicle (e.g., an autonomous vehicle) using trajectory generation. The signal processing system can receive location data that identifies a source and/or destination of the vehicle within an environment. The vehicle can navigate the environment in accordance with a route. For example, the vehicle can navigate the environment by navigating from a source to a destination using a route. The route may be based on different combinations of trajectories or paths between poses. A combination of trajectories may cause navigation from the source to the destination, however, combinations of trajectories may result in different paths. To build the path for the vehicle, the signal processing system can generate a plurality of trajectories. The plurality of trajectories may include multiple sets of trajectories which each correspond to a portion of the route and a particular planning step. For example, the plurality of trajectories may include a first set of trajectories from a first pose to a set of second poses, a second set of trajectories from the set of second poses to a set of third poses, a third set of trajectories from the set of third poses to a set of fourth poses, etc. Prior to selection of a trajectory for a particular portion of the route, the signal processing system can obtain component data associated with the vehicle. For example, the component data may include sensor data associated with a sensor of the vehicle, time data associated with a timer, etc. The signal processing system may adjust the plurality of trajectories based on the component data to identify an adjusted plurality of trajectories. For example, the signal processing system may adjust the plurality of trajectories by removing a trajectory from the plurality of trajectories, adding a trajectory to the plurality of the plurality of trajectories, adjusting a trajectory of the plurality of trajectories, generating an updated plurality of trajectories, etc. The signal processing system can select a trajectory from the adjusted plurality of trajectories for the particular portion of the route. Based on the selected trajectory, the signal processing system can determine a path for the vehicle. As a non-limiting example, the signal processing system dynamically adjusts the generated plurality of trajectories for building a path and selects a trajectory from the adjusted plurality of trajectories.

By virtue of the implementation of systems, methods, and computer program products described herein, a system can generate a path for a vehicle that includes a trajectory from a plurality of trajectories that are adjusted based on component data. The system can generate a plurality of trajectories that are associated with a plurality of planning steps and represent a plurality of routes through an environment. As the plurality of trajectories are associated with a plurality of planning steps, the system can utilize the plurality of trajectories at multiple planning steps. The system can refine and/or update the plurality of trajectories based on selections of trajectories from the plurality of trajectories. By selecting trajectories from the generated plurality of trajectories, the system can avoid replicating computations from a prior planning step and introducing inefficiencies. To verify that the plurality of trajectories satisfy safety constraints, prior to selection of a trajectory, at all or a portion of the plurality of planning steps, the system can identify component data associated with the vehicle to adjust (e.g., update) the plurality of trajectories. For example, the system can identify component data indicating a time period, a pedestrian in the environment, another vehicle in the environment, a bicycle in the environment, etc. Based on the component data, at all or a portion of the plurality of planning steps, the system can dynamically adjust the plurality of trajectories to remove a trajectory, add a trajectory, generate an updated plurality of trajectories, etc. (e.g., based on movement of a pedestrian, expiration of a time period, etc.). Therefore, the system can more efficiently select trajectories from a plurality of trajectories for a vehicle and generate a path for the vehicle. Based on the generated path, the system can more accurately and efficiently perform automated vehicle testing to improve automated vehicle driving behavior. In some cases, the system can generate a path for a vehicle, in real time, by identifying a plurality of trajectories and dynamically adjusting the plurality of trajectories at all or a portion of the planning steps. The dynamic adjustment of the plurality of trajectories enables the system to avoid trajectories that may meet one or more qualifications for selection in the short term (e.g., at generation of the plurality of trajectories), but not in the long term (e.g., at a particular planning step based on movement of a pedestrian) while retaining state data associated with plurality of trajectories which can improve the efficiency of the selection process. Such a trajectory selection can improve the quality and performance of the vehicle.

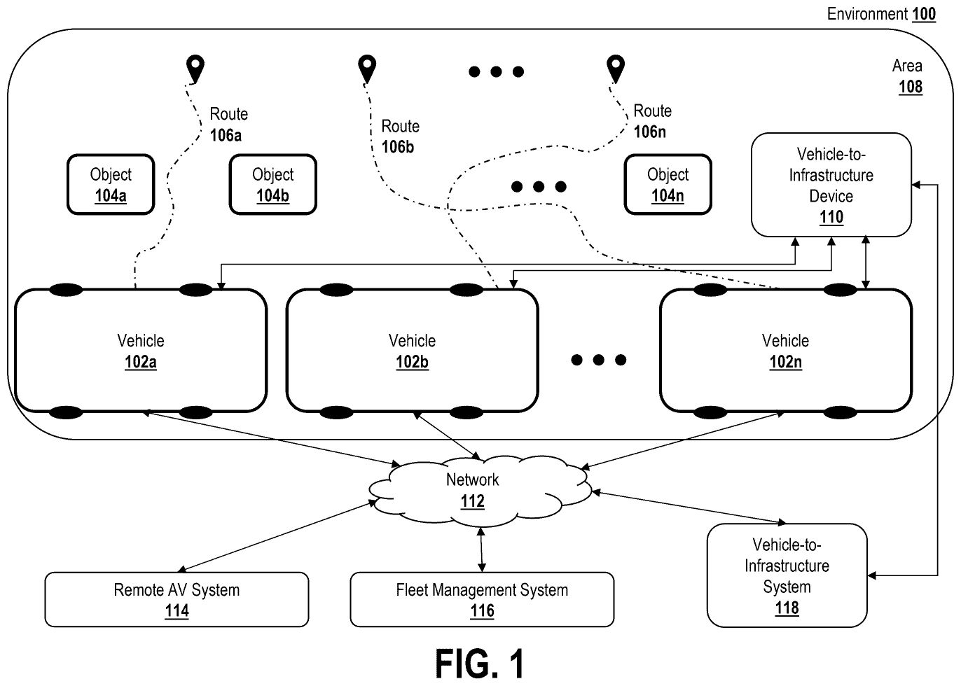

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

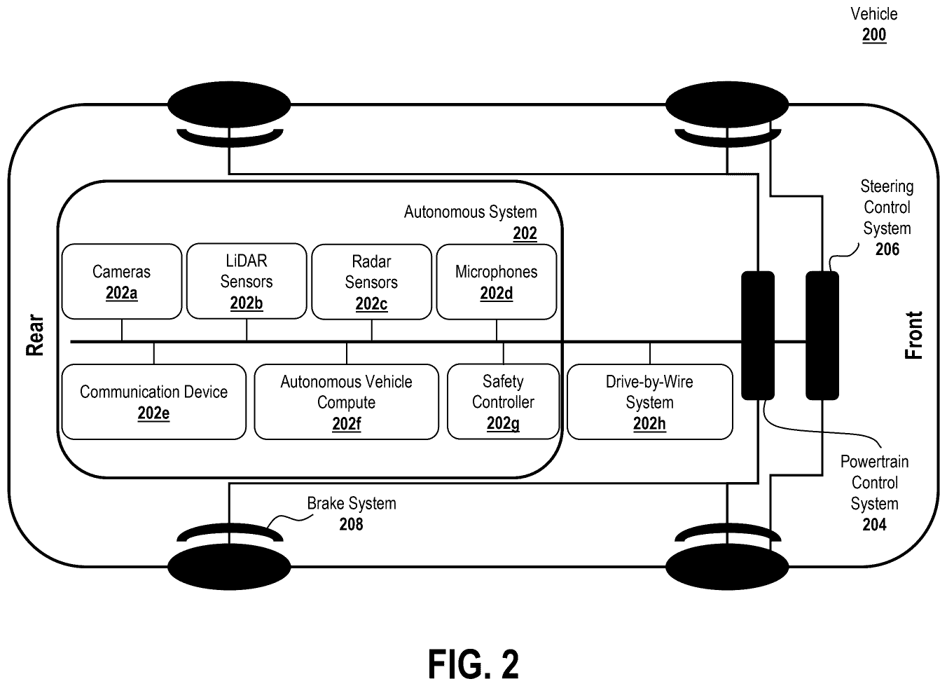

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

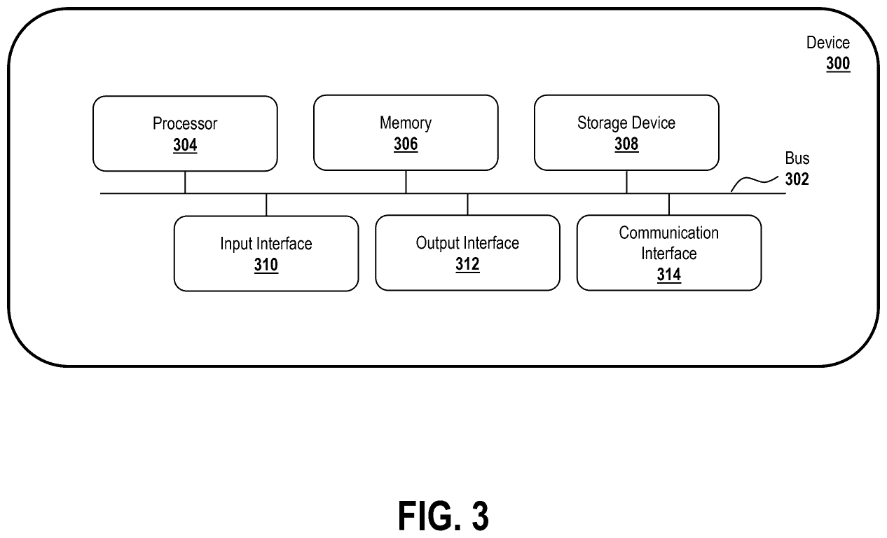

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

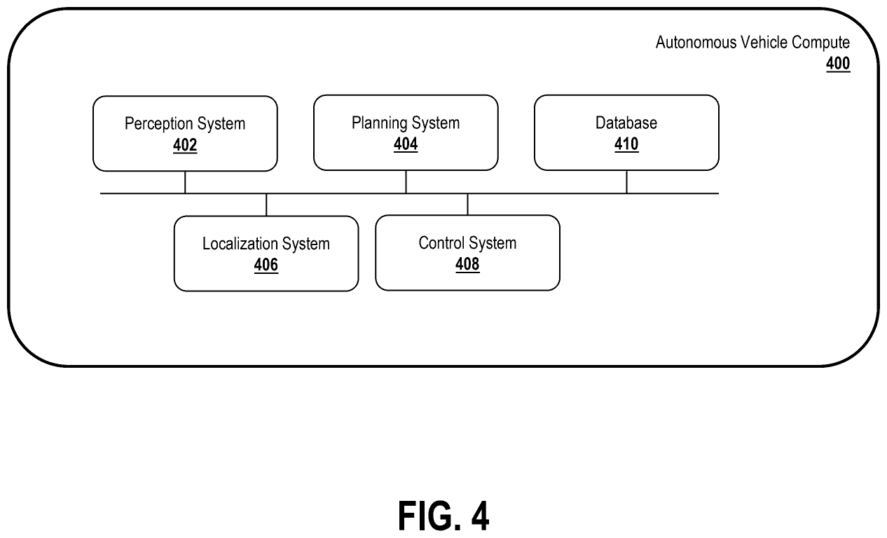

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

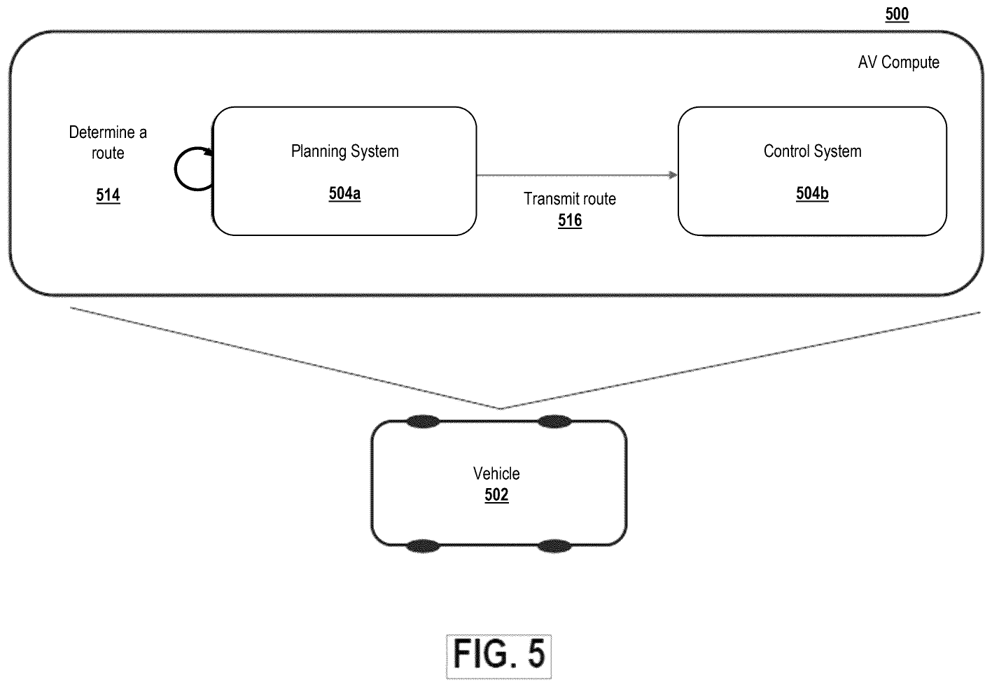

Referring now to FIG. 5, illustrated is a diagram of an implementation 500 of a process for graph exploration for trajectory generation based on a hierarchical plurality of rules. In some embodiments, implementation 500 includes planning system 504a. In some embodiments, planning system 504a is the same as or similar to planning system 404 of FIG. 4. The output of a planning system 504a can be a route from a start point (e.g., source location or initial location) to an end point (e.g., destination or final location). In the example of FIG. 5, the planning system 504a determines the route at reference number 514 and transmits the route at reference number 516 to a control system 504b. During vehicle operation, the control system operates the vehicle to navigate the route. In some embodiments, the route and other AV compute data is stored for after-the fact evaluation of routes selected by the AV to navigate from a start point to an end point. Generally, the route is defined by one or more segments. For example, a segment is a distance to be traveled over at least a portion of a street, road, highway, driveway, or other physical area appropriate for automobile travel. In some examples, e.g., if the AV is an off-road capable vehicle such as a four-wheel-drive (4WD) or all-wheel-drive (AWD) car, SUV, pick-up truck, or the like, the route includes “off-road” segments such as unpaved paths or open fields.

The planning system 504a can output lane-level route planning data (in addition to or instead of the route). The lane-level route planning data can be used to traverse segments of the route based on conditions of a particular segment at a particular time. In some embodiments, the lane-level route planning data is stored for after-the-fact evaluation using graph exploration as described herein. During operation, the lane-level route planning data can be used to traverse segments of the route based on conditions of the particular segment at a particular time. For example, if the route includes a multi-lane highway, the lane-level route planning data includes trajectory planning data that the AV can use to choose a lane among the multiple lanes (e.g., based on whether an exit is approaching, whether one or more of the lanes have other vehicles, or other factors that vary over the course of a few minutes or less as the vehicle moves along a route). Similarly, in some implementations, the lane-level route planning data includes speed constraints specific to a segment of the route. For example, if the segment includes pedestrians or un-expected traffic, the speed constraints may limit the AV to a travel speed slower than an expected speed, e.g., a speed based on speed limit data for the segment.

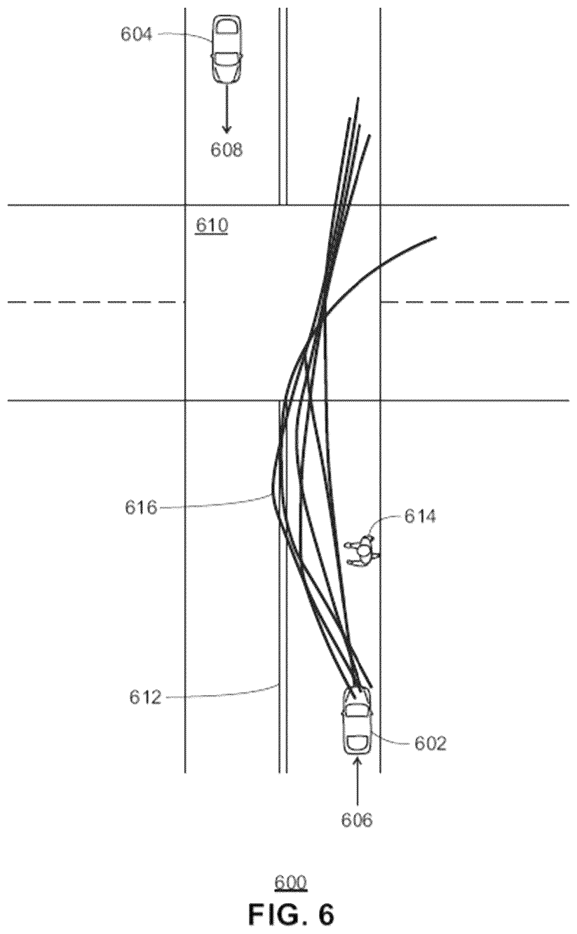

FIG. 6 illustrates an example scenario for AV 602 operation using graph exploration with behavioral rule checks, in accordance with one or more embodiments. The AV 602 may be, for example a vehicle 102 as illustrated and described in more detail with reference to FIG. 1 or a vehicle 200 as illustrated and described in more detail with reference to FIG. 2. The AV 602 operates in an environment 600, which may be an environment 100 as illustrated and described in more detail with reference to FIG. 1. In the example scenario illustrated in FIG. 6, the AV 602 is operating in lane 606 on approach to the intersection 610. Similarly, another vehicle 604 is operating in lane 608 on approach to the intersection 610. The flow of traffic in lane 606 is opposite to the flow of traffic in lane 608, as indicated by the arrows. There is a double line 612 separating lane 606 from lane 608. However, there is no physical road divider or median separating lane 606 from lane 608. The traffic rules in the environment 600 prohibit a vehicle from crossing the double line 612 or exceeding a predetermined speed limit (e.g., 45 miles per hour) in accordance with generally understood rules of the road.

The AV 602 is operating in the lane 606 to navigate to a destination beyond the intersection 610. As illustrated, a pedestrian 614 is located in the lane 606, blocking the lane 606. Other objects can block the AV's planned trajectory, such as incidents that block a lane of travel, vehicle breakdowns, construction, cyclists, and the like. In some embodiments, the AV 602 uses a perception system 402 to identify the objects, such as the pedestrian 614. The perception system 402 is illustrated and described in more detail with reference to FIG. 4. Generally, the perception system 402 classifies objects into types such as automobile, roadblock, traffic cones, etc. The classifications are provided to the planning system 404. The planning system 404 is illustrated and described in more detail with reference to FIG. 4.

The AV 602 determines that the lane 606 is blocked by the pedestrian 614. In examples, the AV 602 detects the boundaries of the pedestrian 614 based on characteristics of data points (e.g., sensor data) detected by the sensors 202 of FIG. 2. To reach the destination, a planning system 404 (FIG. 4) of the AV 602 generates the trajectories 616. Operating the AV 602 in accordance with one or more of the trajectories 616 causes the AV 602 to violate a traffic rule and cross the double line 612 to maneuver around the pedestrian 614 so that the AV 602 reaches its destination. Some of the trajectories 616 cause the AV 602 to cross the double line 612 and enter lane 608, in the path of the vehicle 604. The AV 602 uses a hierarchical plurality of rules (e.g., a hierarchical set of rules of operation) to provide feedback on the driving performance of AV 602. The hierarchical plurality of rules is sometimes referred to as a stored behavioral model or a rulebook. In some embodiments, the feedback is provided in a pass-fail manner. The embodiments disclosed herein detect when the AV 602 (e.g., the planning system 404 of FIG. 4) generates trajectories 616 that violate rules (e.g., behavioral rules), and determines whether the AV 602 could have generated an alternative trajectory that would have violated one or more lower-priority behavioral rules (e.g., behavioral rules with a lower priority than the trajectories 616 based on the hierarchical plurality of rules). The occurrence of such a detection denotes a failure of the motion planning process. The present techniques use graph exploration to heuristically determine a trajectory from the trajectories 616 that navigate past the pedestrian 614 in lane 606 and reaches a destination (e.g., goal). In some embodiments, the trajectory is a trajectory that begins at a starting pose and violates the behavioral rule with the lowest priority as compared to the priority of behavioral rules violated by other trajectories of the trajectories 616.

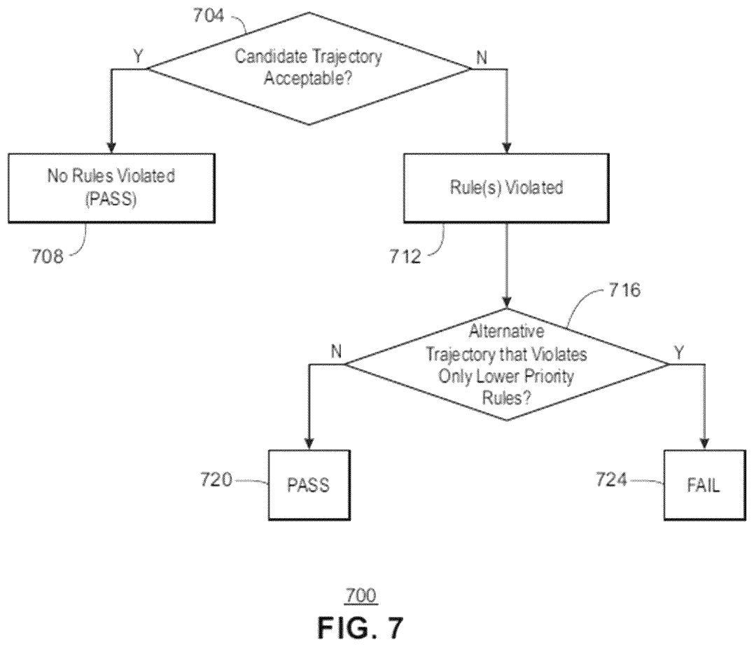

In some embodiments, at least one processor receives sensor data after the operation of the AV. The sensor data is representative of scenarios encountered by the AV while navigating through the environment. Hierarchical rules of the hierarchical plurality of rules are applied to scenarios simulated by an AV stack to modify and improve the AV development after-the-fact (e.g., after operation of the AV, where sensor data is captured). In examples, this offline framework is configured to develop a transparent and reproducible rule-based pass/fail evaluation of AV trajectories in test scenarios. For example, in an offline framework, a given trajectory output by the planning system 404 is rejected if a trajectory that leads to a lesser violation of the rule priority structure (e.g., a rule with a lower priority as compared to the priority of the rule violated by the trajectory) is found. The planning system is modified and improved based on, at least in part, the rejected trajectory and data associated with the rejected trajectory. In some embodiments, the present techniques receive a fixed set of trajectories generated after-the-fact from a given scenario and determines a particular trajectory to evaluate if the AV passes or fails a predetermined test. The present techniques use a set of fixed trajectories to create a graph. In some embodiments, the graph is an edge weighted graph and weights are assigned to edges that correspond to trajectories based on rule violations. Each trajectory can be associated with one or more costs, each cost corresponding to a rule violation. Determining the fixed set of trajectories is described with respect to FIG. 7.

FIG. 7 illustrates an example flow diagram of a process 700 for vehicle operation using behavioral rule checks to determine a fixed set of trajectories. In some embodiments, the process of FIG. 7 is performed by the AV 200 of FIG. 2, the device 300 of FIG. 3, the AV compute 400 of FIG. 4, or any combinations thereof. In some embodiments, at least one processor located remotely from a vehicle performs the process 700 of FIG. 7. Likewise, embodiments may include different and/or additional steps, or perform the steps in different orders.

At block 704, it is determined that a trajectory (e.g., trajectories 616) for the AV 602 is acceptable (e.g., whether the trajectory violates a rule of the hierarchical plurality of rules). The trajectories 616 and AV 602 are illustrated and described in more detail with reference to FIG. 600. In some examples, a trajectory is determined to be acceptable based on the hierarchical plurality of rules. If no rules are violated by the trajectory, the trajectory is acceptable and the process moves to step 708 and the planning system 404 and AV behavior pass the verification checks. The planning system 404 is illustrated and described in more detail with reference to FIG. 4.

If a rule is violated by the trajectory, the process moves to block 712 to determine the rule(s) violated by the trajectory. The violated rule is denoted as a first behavioral rule having a first priority. The process moves to block 716. At block 716, the processor determines whether an alternative trajectory is available for the AV 602 that violates a behavioral rule with a lower priority than the first priority. For example, the processor generates multiple alternative trajectories for the AV 602 based on sensor data associated with a scenario. In some embodiments, the sensor data characterizes information associated with the AV, information associated with the objects, information associated with the environment, or any combinations thereof. The processor identifies whether a second trajectory from the multiple alternative trajectories is available that violates a second behavioral rule of the hierarchical plurality of rules with a second priority that is less than the first priority (e.g., the second trajectory does not violate a behavioral rule with a priority that is greater than or equal to the first priority). In some examples, if no other trajectory is available that violates (e.g., only violates) a second behavioral rule with a priority lower than the first priority, the process moves to block 720 and the planning system 404 passes the verification checks. At block 716, if an alternative trajectory is available for the AV 602 that violates a behavioral rule with a lower priority than the first priority, the planning system 404 fails the verification checks. Thus, the planning system 404 can identify a trajectory for a vehicle that violates a rule with a particular priority in order to avoid violating a rule with a higher comparative priority (e.g., a worse scenario).

In some examples, an AV is operable according to a hierarchical plurality of rules. Each behavioral rule has a priority with respect to each other rule. For example, a hierarchical plurality of rules (e.g., a rulebook) can include the following rules, in increasing order of priority: 1: maintain a predetermined speed limit; 2: stay in lane; 3: maintain a predetermined clearance; 4: reach goal; 5: avoid collisions. In some examples, the priority represents a risk level of a violation of the behavioral rules. The hierarchical plurality of rules may, in some cases, be implemented as a formal framework to specify driving requirements enforced by traffic laws, cultural expectations, safety considerations, driving norms, etc. as well as their relative priorities. In certain cases, the hierarchical plurality of rules may be implemented as a pre-ordered set of rules having violation priorities (e.g., scores) that capture the hierarchy of the rule priorities. Hence, the hierarchical plurality of rules enables AV behavior specification and assessment in conflicting scenarios.

Referring again to FIG. 6, consider the case where a pedestrian 614 enters the lane in which the AV 602 is traveling. The hierarchical plurality of rules may indicate that the highest priority of the AV 602 is to avoid collision with the pedestrian 614 and other vehicle 604 (e.g., satisfy rule 5: avoid collision, highest priority in the exemplary hierarchical plurality of rules) at the cost of violating lower priority rules, such as reducing speed to less than a minimum speed limit (e.g., violation of rule 1: maintain a predetermined speed limit) or deviating from a lane (e.g. violation of rule 2: stay in lane). For example, generation of the hierarchical plurality of rules may be an after-the-fact prioritization of actions the AV should take based on perfect information (e.g., knowing predetermined values or states) associated with the scenario.

In some cases, the AV may determine a trajectory of the AV that causes a violation of a behavioral rule such that the AV exceeds a predetermined speed limit (e.g., 45 mph). For example, the rule (1) may be to maintain a predetermined speed limit, denoting that the AV should not violate the speed limit of the lane it is traveling in. In the aforementioned example, the priority of rule (1) is lower than the priority of rule (5): avoid collisions, rule (4): reach goal, rule (3): maintain clearance, and/or rule (2): stay in lane. Thus, the AV may violate rule (1) to avoid violating rules (2), (3), (4) and/or (5).

In an embodiment, the AV may determine a trajectory of the AV that causes a violation of a behavioral rule such that the AV stops before reaching a destination. In examples, rule (2) may be to stay in lane, denoting that the AV should stay in its own lane. The priority of rule (2) is lower than the priority of rule (5): avoid collisions, rule (4): reach goal, and/or rule (3): maintain clearance. Thus, the AV may violate rule (1) or rule (2) to avoid violating rules (3), (4), and/or (5).

In an embodiment, the AV may determine a trajectory of the AV that causes a violation of a behavioral rule such that a lateral clearance between the AV and the objects near the AV decreases below a threshold lateral distance. For example, rule (3) may be to maintain a predetermined clearance, denoting that the AV should maintain a threshold lateral distance (e.g., one half car length or 1 meter) from any other object (e.g., pedestrian 614). The priority of rule 3 is lower than the priority of rule (5): avoid collisions, and/or rule (4): reach goal, and the AV can violate rules (1), (2), or (3) to avoid violating rules (4) and/or (5).

In some embodiments, the sets of alternative trajectories are generated based on driver and/or driving behavior. For example, the trajectories may include trajectories generated based on driver behavior (e.g., human driver behavior), trajectories generated based on driving behavior (e.g., trajectories generated by a model), training trajectories, or any other trajectories. The trajectories may be grouped into a plurality of trajectory sets, and can be stitched together to generate a graph of trajectories. In some embodiments, the trajectory sets may represent some or all of the trajectories the AV can take with respect to a starting pose (e.g., location, speed, heading, and/or acceleration). Accordingly, the trajectories may include paths that are possible in view of a pose.

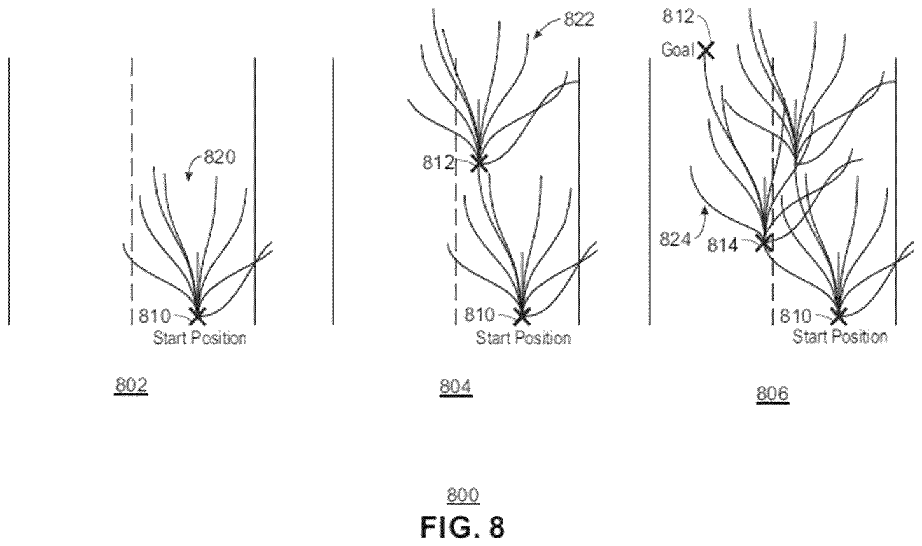

FIG. 8 is an illustration of iteratively growing graphs 800 to determine a trajectory that violates a rule with a lowest priority (and/or violates no rules) as compared to rules violated by other trajectories after-the-fact. In some embodiments, the generated graphs 802, 804, and 806 are explored to determine a trajectory that represents a preferred path for the vehicle to take through an environment. The preferred path can be used to compare a trajectory taken by the AV in a same scenario associated with the determined trajectories according to the present techniques. The graph generation enables evaluation of an AV response in view of a determined trajectory.

In some embodiments, a preferred trajectory changes over time or based on different locations. Put another way, a preferred trajectory at a first pose might cause a violation of higher priority rules at subsequent poses. For example, during travel through an environment, based on a preferred trajectory at a first pose, the AV can get stuck (e.g., unable to plan a path forward) or left to follow a path that creates a particular rule violation.

In some cases, trajectories are generated without positive reinforcement of selected (e.g., traversed or navigated) trajectories as the AV travels. In traditional techniques, generated trajectories can deteriorate over time. The present techniques evaluate candidate trajectories at a series of poses, such that a subset of the trajectories at a series of poses are selected according to the hierarchical plurality of rules. The trajectories are iteratively traversed to generate a graph of trajectories from a starting pose to a goal pose. The present techniques create a graph based on the fixed set of trajectories. In some embodiments, the generated graph captures vehicular dynamics from the fixed trajectory sets using the series of poses.

In the example of FIG. 8, a first pose 810 of the AV is at the start position. From the start position, a set of alternative trajectories 820 for a vehicle at a first pose 810 (e.g., root node of the corresponding graph) are generated, the set of alternative trajectories representing operation of the vehicle from the first pose 810. In the set of alternative trajectories, one or more trajectories are determined (e.g., trajectories that cause a violation of rules from the hierarchical plurality of rules with a priority lower than the priority of rules violated by other trajectories from the set of alternative trajectories 820). The determined trajectories are used to determine next poses, and a next set of alternative trajectories 822 and 824 are generated from the next poses. In particular, a next pose 812 is evaluated to generate a next set of alternative trajectories 822. A next pose 814 is evaluated to generate a next set of alternative trajectories 824. In some embodiments, sets of alternative trajectories are iteratively generated until the goal/destination 812 is reached.

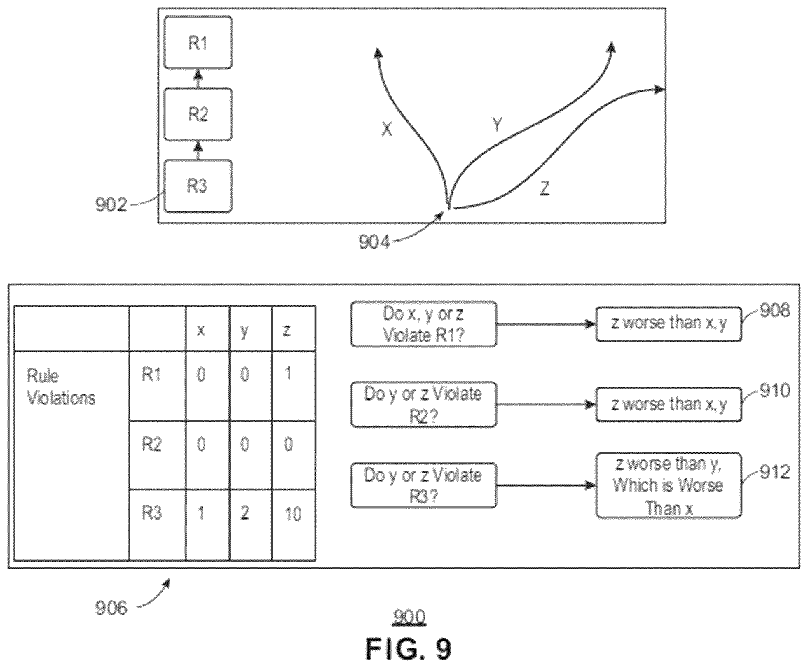

As illustrated in FIG. 8, the graphs 802, 804, and 806 are generated by calculating a set of alternative trajectories 820 at a first pose 810 in a given scenario. From the set of alternative trajectories 820, the one or more trajectories (e.g., a random or pseudo-random subset of the set of alternative trajectories 820) are determined. In some examples, one or more trajectories are selected based on causing a violation of rules of the hierarchical plurality of rules with the lowest (or lower) priority as compared to rule violations of other trajectories of the set of alternative trajectories 820. For example, a preordered list of priorities according to the rule violations can be associated with each trajectory of the graph. An example of this priority is described below with respect to FIG. 9. Generally, the numbers of trajectories selected for each set of trajectories (e.g., each layer of graph growing) enables tuning of the quality of the graph as compared to the speed of computing the graph. A larger number of trajectories can cause exponential increases in computation time, however the quality of the resulting graph also increases.

In some embodiments, the set of alternative trajectories 820 is grown with the next set of alternative trajectories 822, 824. For example, a next pose (e.g., next pose 812, 814) at the end of a selected trajectory of the set of alternative trajectories 820 is used to iteratively generate a next (e.g., random) set of alternative trajectories (e.g., the next set of alternative trajectories 822, 824). The trajectories that are retained from the next set of alternative trajectories can be trajectories that cause a violation of rules from the hierarchical plurality of rules with a priority lower than the priority of rules violated by other trajectories from the next set of alternative trajectories. Graph growth can continue until one or more trajectories are generated that reach the goal 812 or a timeout occurs. The timeout may be a predetermined period of time before graph generation is terminated. In some examples, the timeout can be canceled or overridden to continue graph generation. The trajectories (e.g., the path) selected for the graph can be those trajectories from the first pose to the goal that have a lowest priority according to the hierarchical plurality of rules.

FIG. 9 is a diagram of system 900 that calculates a priority (e.g., a score) for all or a portion of trajectories according to a hierarchical plurality of rules. A path can include multiple trajectories and the system 900 can calculate a priority of the path based on a highest priority of a trajectory of the path as compared to other trajectories of the path, a cumulative priority of the priorities of all or a portion of the trajectories of the path, etc. In the example of FIG. 9, a hierarchical plurality of rules 902 provides three exemplary hierarchical rules: R1 (highest priority), R2 (next highest priority), R3 (lowest priority). The system 900 can assign all or a portion of the hierarchical rules a base priority based on the hierarchical plurality of rules 902. The system 900 can further determine a priority of a violation of a rule by a trajectory based on the base priority and a level of a violation of the rule. For example, the hierarchical plurality of rules 902 indicates that a violation of rule R1 has a priority of 1 and the system 900 determines that a singular violation of rule R1, a lesser violation of rule R1 (as compared to other violations), etc. has a priority of 1 and multiple violations of rule R1, a greater violation of rule R1 (as compared to other violations), etc. has a priority of 2. Additionally, a fixed set of trajectories 904 includes a trajectory x, trajectory y, and trajectory z. The fixed set of trajectories may be the same as or similar to the trajectories 616 (FIG. 6) or trajectories 820, 822, or 824 of FIG. 8. In some embodiments, the fixed set of trajectories represent all or a portion of the actions that vehicles can make in traffic situations. In some examples, the fixed set of trajectories is generated using a planning system of an AV (e.g., planning system 404 of FIG. 4) in response to simulation in a predetermined scenario. In examples, the predetermined scenario is represented by AV compute inputs and outputs as the AV travels from a starting pose toward a destination.

In some embodiments, the priority represents a comparative level of a rule violation as compared to the level of rule violation by one or more other trajectories. For example, each individual rule is independently evaluated and compared to all or a portion of the other trajectories. The priority can be based on, at least in part, the particular rule. For example, for a rule associated with a minimum clearance between the AV and a pedestrian, the priority is based on the number of violations (e.g., instantaneous violations) of clearance associated with the AV and one or more pedestrians, the distance between the AV and a pedestrian, etc. In this example, the violations are entering a space near the pedestrian by violating a clearance between the AV and the pedestrian. Each trajectory can be ranked based on the number of violations, the type of violations, the magnitude of violations, etc. according to a lexicographic order.

In the example of FIG. 9, system 900 identifies rule violations caused by all or a portion of the fixed set of trajectories to determine rule violation priorities 906 for each trajectory. In particular, the system 900 evaluates all or a portion of the rules to determine the rule violation priorities for a trajectory. At evaluation 908, the system 900 evaluates rule R1 to determine if trajectory x, trajectory y, or trajectory Z violates rule R1. In the example of FIG. 9, the system 900 determines that trajectory z violates rule R1, while trajectory x and trajectory y do not violate rule R1. The system 900 assigns trajectory z a priority of 1 with respect to rule R1. The system 900 assigns trajectories x and y a priority of 0 with respect to rule R1. At evaluation 910, the system 900 evaluates rule R2 to determine if trajectory x, trajectory y, or trajectory Z violates rule R2. In the example of FIG. 9, no trajectory violates rule R2. The system 900 assigns each trajectory a priority 0 with respect to rule R2. At evaluation 908 trajectory z is the only trajectory that violates R1, so the system 900 assigns a priority for violation of rule R1 to trajectory z. At evaluation 902, no trajectory violates rule R2 so the system 900 does not assign a priority for violation of rule R2 to any of the trajectories (or assigns a priority of 0).

At evaluation 912, the system 900 evaluates rule R3 to determine if trajectory x, trajectory y, or trajectory z violates rule R3. In the example of FIG. 9, the system 900 determines trajectory z violates rule R3 worse than trajectory y violates rule R3, which in turn violates rule R3 worse than trajectory x. violates rule R3 The system 900 assigns trajectory z a priority of 10 with respect to rule R3, where 10 is the maximum number of violations of rule R3. The system 900 assigns trajectory x a priority of 1, and trajectory y a priority of 2 with respect to rule R3.

In some examples, from a set of fixed trajectories, the system 900 can determine a random subset of the trajectories. The determined trajectories can be the trajectories that have a priority above a predetermined threshold with respect to all or a portion of the rules. In some examples, the system 900 can select all or a portion of the trajectories that have a priority above the predetermined threshold according to the hierarchical plurality of rules for the graph. In some embodiments, the system 900 generates a second set of trajectories from poses located at the end of the determined trajectories (e.g., the system grows the determined trajectories). Graph growth can continue until one or more paths of trajectories are generated that reach the goal pose. The system 900 can select a path for the graph from the first pose to the goal pose that has a lowest priority (e.g., cumulative or total priority) as compared to other paths that reach the goal pose according to the hierarchical plurality of rules. In this manner, the system 900 can generate the graph as a guided heuristic using the behavior modeling and prediction data set. In some examples, the present techniques do not converge on a singular trajectory or path. For example, the system 900 can obtain multiple trajectories or paths with a particular priority.

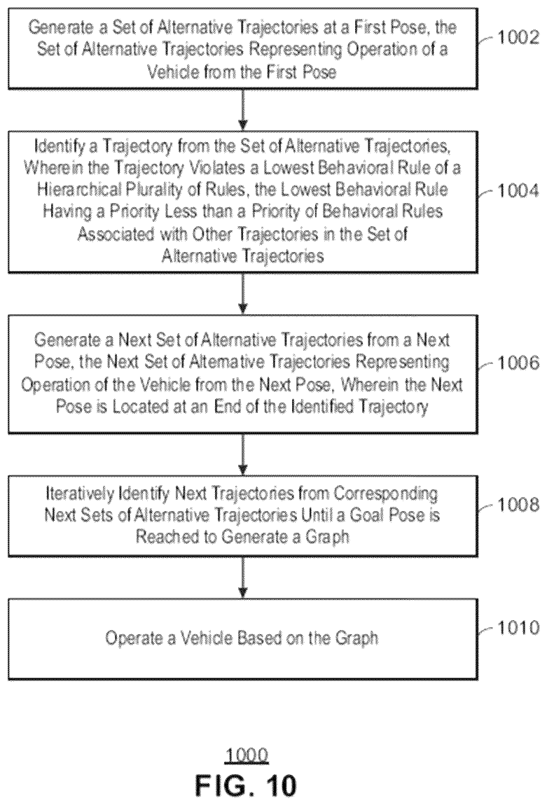

Referring now to FIG. 10, illustrated is a flowchart of a process 1000 for graph exploration for trajectory generation based on a hierarchical plurality of rules. In some embodiments, one or more of the steps described with respect to process 1000 are performed (e.g., completely, partially, and/or the like) by autonomous vehicle 200 of FIG. 2 or AV computer 400 of FIG. 4. Additionally, or alternatively, in some embodiments one or more steps described with respect to process 1000 are performed (e.g., completely, partially, and/or the like) by another device or group of devices separate from or including autonomous system 400 such as device 300 of FIG. 3.

At block 1002, a set of alternative trajectories for a vehicle at a first pose are generated. In some embodiments, the alterative trajectories are sets of trajectories generated using behavior prediction. In some embodiments, the first pose is a root node of the corresponding graph. The set of alternative trajectories represent operation of the vehicle from the first pose.

At block 1004, a trajectory from the set of alternative trajectories is identified. In some embodiments, the trajectory violates a behavioral rule of a hierarchical plurality of rules with a priority less than a priority of behavioral rules violated by other trajectories in the set of alternative trajectories. Accordingly, in some embodiments, the present techniques select the one or more trajectories at the first node that cause a violation of a lowest priority rule as compared to violations of other rules by other trajectories.

At block 1006, a next set of alternative trajectories is generated from a next pose at the end of the trajectory responsive to identifying the trajectory. The next set of alternative trajectories represents operation of the vehicle from the next pose. In this manner, the graph is iteratively grown based on the next pose at the end of the identified trajectory. The next set of alternative trajectories for the vehicle may be generated from the next pose by applying vehicle dynamics associated with the next pose to possible trajectories associated with a location of the next pose. Vehicle dynamics include, for example, speed, location, acceleration, and orientation associated with the trajectory at the next pose.

At block 1008, next trajectories from corresponding next sets of alternative trajectories are iteratively identified. In some embodiments, a next trajectory violates a behavioral rule of the hierarchical plurality of rules with a priority less than a priority of behavioral rules violated by other trajectories in a corresponding next set of alternative trajectories until a goal pose is reached to generate a graph. Put another way, in some embodiments, the present techniques iteratively repeat steps of identifying a trajectory from a set of trajectories at a pose at the end of a previously identified trajectory until the goal pose is reached. In some embodiments the trajectory does not reach a goal pose, and the present techniques iteratively repeat steps of identifying a trajectory at the end of a previously identified trajectory until a predetermined timeout occurs. In some examples, the trajectory is the trajectory that violates the lowest priority behavioral rules as compared to other trajectories, where the trajectories are ranked according to rule violations in a hierarchical plurality of rules. Growing the graph generally continues until a path to the goal pose from the first pose is identified as described above. At block 1010, a vehicle is operated based on the graph. In examples, vehicle operation based on the graph includes extracting a path (e.g., one or more trajectories) from the graph and comparing a trajectory taken by a vehicle to the trajectories of the extracted path. In this manner, performance of the vehicle is evaluated in view of a determined trajectory. The trajectories of the path extracted from the graph can be used to provide feedback on vehicle performance.

### Dynamic Adjustment of Generated Trajectories

A system can operate a vehicle to move along a route (e.g., from a first location to a second location). As the vehicle moves along the route, the vehicle can encounter a number of objects (e.g., pedestrians, other vehicles, traffic lights, traffic signs, road work, traffic, etc.). In response, the vehicle can generate one or more trajectories or paths around the objects. The system can define a route from a source to a destination based on the trajectory or path. For example, the route can be based on multiple paths or trajectories. However, the generated trajectories or paths can violate one or more rules, such as but not limited to traffic laws, cultural expectations of driving behavior, a destination, etc. As discussed above, the rules can be grouped into a hierarchical plurality of rules that defines a priority of all or a portion of the rules.

As all or a portion of the paths can cause a violation of a different rule with a different (e.g., lower) priority or may not cause a violation of rule, the system can select a path that causes a violation of a rule with the lowest priority or no violation of a rule. The operation of the vehicle according to a path that causes a violation of a higher priority rule when a path that causes a violation of lower priority rule is available can produce adverse effects, such as increasing the likelihood of a collision or causing discomfort to passengers.

To identify a path around one or more objects, the system can select a trajectory from a plurality of trajectories in different planning steps (e.g., cycles, intervals, etc.) for the path based on the priority of rules violated by the trajectories of the plurality of trajectories. For example, in a first planning step, the system can select a first trajectory (T1) based on a priority of a rule (P1) violated by the first trajectory compared to a priority of rules (e.g., P2, P3) violated by other trajectories (e.g., T2, T3) from a first set of the plurality of trajectories. In a second planning step, the system can select a second trajectory branched from the first trajectory (e.g., T1.TA) based on a priority of a rule (P4) violated by the second trajectory compared to a priority of rules (e.g., P5, P6) violated by other trajectories (e.g., T1.TB, T1. TC) from a second set of the plurality of trajectories. Accordingly, the system can iteratively select a trajectory in a planning step from a pose located at an end of a trajectory selected in a prior planning step. Therefore, systems can generate a path by iteratively selecting trajectories branched from trajectories selected during previous planning steps. The systems can generate a route by combining one or more paths.

In some cases, the systems may generate trajectories at all or a portion of the planning steps and select a trajectory from the generated trajectories. For example, the systems may generate trajectories de novo in real time at all or a portion of the planning steps. The systems may generate the trajectories at all or a portion of the planning steps to account for changes in the environment of the vehicle. For example, a pedestrian may begin or may finish crossing a road, a vehicle may begin or may finish switching lanes, etc. after a first planning step and before a second planning step. By generating the trajectories at all or a portion of the planning steps, the systems can respond to the changes in the environment (e.g., by braking based on a pedestrian who is beginning to cross the road on which the vehicle is operating).

The iterative generation and selection of trajectories at all or a portion of the planning steps, however, may not define a preferred path (e.g., a path with a lower number of violations or an overall lower priority of violations). For instance, while a trajectory selected during a second planning step from a generated plurality of trajectories may violate a rule with a lowest priority as compared to the priority of other rules violated by other trajectories of the generated plurality of trajectories, because the plurality of trajectories is generated de novo in real time, the generated plurality of trajectories may be limited in complexity and/or quantity. For example, the systems may be limited to generating the plurality of trajectories over a particular period of time (e.g., 100 milliseconds) and/or may be limited to generating a particular number of trajectories (e.g., 3 trajectories) as a result of generating the trajectories de novo and in real time at all or a portion of the planning steps.

Additionally, the systems may replicate computations across planning steps as the systems may iteratively generate and select trajectories at all or a portion of the planning steps without regard to trajectories generated and selected during a prior planning step. As the environment may not be modified between planning steps and/or may be modified in such a manner that may not affect the trajectories generated, the systems can replicate computations used to generate trajectories across planning steps. Such a replication of computations can result in a computationally inefficient and power intensive trajectory selection.

In some cases, the systems may generate a plurality of trajectories that includes trajectories for all or a portion of the planning steps and may select a trajectory from the generated trajectories. For example, the systems may generate a plurality of trajectories prior to all or a portion of the planning steps. The systems may generate the trajectories for all or a portion of the planning steps based on the environment of the vehicle at a particular period of time. For example, the systems may generate the trajectories for all or a portion of the planning steps based on the presence of a pedestrian on the edge of a road, another vehicle approaching the vehicle, etc. By generating the trajectories prior to all or a portion of the planning steps, the systems may not be limited to generating the trajectories over a particular period of time and/or may not be limited to generating a particular number of trajectories.

The generation and selection of trajectories prior to all or a portion of the planning steps, however, may not define a preferred path (e.g., a path with a lower number of violations or an overall lower priority of violations). For instance, while a trajectory selected during a second planning step from a plurality of trajectories generated prior to the second planning step (e.g., during a first planning step) may violate a rule with a lower priority as compared to the priority of other rules violated by other trajectories of the generated plurality of trajectories, because the trajectories are generated prior to the second planning step, the generated plurality of trajectories may not reflect changes in the environment of the vehicle. For example, a pedestrian may begin or may finish crossing the road, a vehicle may begin or may finish switching lanes, etc. after a first planning step and before a second planning step. By generating the trajectories prior to all or a portion of the planning steps, all or a portion of the trajectories may violate a rule with a higher priority during a second planning step as compared to a first planning step. For example, during a first planning step, a trajectory may violate a rule with a first priority and, during a second planning step, based on changes to the environment of the vehicle, a trajectory may violate a rule with a second priority which may be higher than the first priority. Therefore, the selected trajectories for a path may not represent a path that causes a violation of a rule with the lowest priority.

To address these issues, the planning system 404 can generate a plurality of trajectories (e.g., prior to all or a portion of the planning steps). For example, the planning system 404 can generate the plurality of trajectories based on first sensor data associated with one or more sensors of the vehicle. At all or a portion of the planning steps, the planning system 404 can obtain component data (e.g., second sensor data associated with the one or more sensors of the vehicle) associated with the vehicle. For example, the component data may include sensor data associated with a sensor of the vehicle (e.g., a lidar sensor, an image sensor, a radar sensor, etc.), time data associated with a timer, etc. In some cases, the component data may include second sensor data that is received by the planning system 404 after the first sensor data (the first sensor data used to generate the plurality of trajectories).

Based on the component data, the planning system 404 can determine whether and/or how to adjust the plurality of trajectories. For example, the planning system 404 can analyze the component data to determine a time period from generation of the plurality of trajectories, determine a change in the environment of the vehicle, etc. Based on determining whether and/or how to adjust the plurality of trajectories, the planning system 404 can obtain an adjusted plurality of trajectories and select a trajectory from the adjusted plurality of trajectories.

By adjusting the plurality of trajectories (instead of generating a new plurality of trajectories without regard to the plurality of trajectories), the planning system 404 can utilize computations performed in a prior planning step such that the efficiency of the trajectory selection is increased. For example, the planning system 404 can utilize computations performed to select and/or implement another trajectory (e.g., a prior trajectory in a path or route). Further, by adjusting the plurality of trajectories, the planning system 404 can reduce the computational intensity and/or complexity of the trajectory selection. Such a reduction in the computational intensity and/or complexity can reduce the cost associated with the path determination process as compared to some systems that generate a plurality of trajectories at each planning step.

In some cases, to adjust the plurality of trajectories, the planning system 404 may remove a trajectory from the plurality of trajectories. For example, the planning system 404 may obtain component data indicating a presence of a pedestrian in the road that may not have been identified for generation of the plurality of trajectories. Based on identifying the presence of the pedestrian in the road and based on determining the presence of the pedestrian was not identified for generation of the plurality of trajectories, the planning system 404 may remove trajectories from the plurality of trajectories that cause a violation of a particular rule associated with the pedestrian (e.g., that cause that vehicle to approach within a particular distance of the pedestrian) to obtain the adjusted plurality of trajectories. The planning system 404 may select a trajectory for the vehicle from the adjusted plurality of trajectories that excludes the removed trajectory.

In some cases, to adjust the plurality of trajectories, the planning system 404 may add a trajectory to the plurality of trajectories. For example, the planning system 404 may obtain component data indicating a lack of a presence of a pedestrian in the road that may have been identified for generation of the plurality of trajectories. Based on identifying the lack of a presence of the pedestrian in the road and based on determining the presence of the pedestrian was identified for generation of the plurality of trajectories, the planning system 404 may add trajectories to the plurality of trajectories (e.g., trajectories that were not added to the plurality of trajectories based on determining the presence of the pedestrian) to obtain the adjusted plurality of trajectories. The planning system 404 may select a trajectory for the vehicle from the adjusted plurality of trajectories that includes the added trajectory.

In some cases, to adjust the plurality of trajectories, the planning system 404 may generate the adjusted plurality of trajectories. For example, the planning system 404 may obtain component data indicating a time period since generation of the plurality of trajectories, one or more changes to the environment of the vehicle, etc. Therefore, based on the component data, the planning system 404 may generate the adjusted plurality of trajectories. For example, all or a portion of the adjusted plurality of trajectories may be different from the plurality of trajectories. The planning system 404 may generate the adjusted plurality of trajectories without regard to the plurality of trajectories. The planning system 404 may select a trajectory for the vehicle from the adjusted plurality of trajectories.

The planning system 404 may use multiple planners to generate the plurality of trajectories and adjust the plurality of trajectories. In some cases, the planning system 404 may use a single planner to generate the plurality of trajectories and adjust the plurality of trajectories (e.g., a partitioned planner, a layered planner, etc.).

In some cases, the planning system 404 may include a first planner (e.g., a stateful planner) to generate the plurality of trajectories and a second planner (e.g., a stateless planner) to adjust the plurality of trajectories. For example, the planning system 404 may include a hybrid planner (e.g., a hybrid reflective/reflexive planner), a dual planner, etc. The planning system 404 may (e.g., simultaneously) provide sensor data associated with at least one sensor of a vehicle and/or location data associated with the vehicle to the first planner and the second planner.

The first planner may be a more computationally intensive planner as compared to the second planner. For example, the first planner may use more processor power and/or may have longer compute times (e.g., 100 ms to 10 s) as compared to the processing power used by and/or the compute times of the second planner (e.g., 10 ms to 100 ms). Further, the first planner may consider state data (e.g., long term state data) associated with the plurality of trajectories in generating the plurality of trajectory whereas the second planner may consider updated sensor data and not the state data in adjusting and selecting a trajectory. Therefore, the first planner may generate higher-quality trajectories as compared to trajectories generated by the second planner, however, the first planner may require longer compute times as compared to the second planner. For example, the first planner may generate trajectories based on previous selected trajectories such that the transition between trajectories is smoother, calmer, includes less flicker, etc. as compared to transitions between other trajectories. By using the state data, the first planner may generate trajectories having smother smoother transitions between trajectories such that a user experience is improved as compared to trajectories generated by the second planner.

The first planner may generate and refine (e.g., adjust the plurality of trajectories, adjust how a subsequent plurality of trajectories is generated, etc.) the plurality of trajectories based on first sensor data (obtained at a first time period) and the second planner may adjust the plurality of trajectories and select a particular trajectory based on second sensor data (obtained at a second time period). Therefore, the second planner may adjust the plurality of trajectories and select a trajectory using sensor data that is updated, more up to date, etc. as compared to the sensor data used to generate the plurality of trajectories (e.g., the sensor data used to generate the plurality of trajectories may be outdated when the adjustment of the plurality of trajectories occurs). As the second planner may be utilizing sensor data that is updated compared to the sensor data utilized by the first planner, the second planner may provide safer trajectories as compared to the trajectories provided by the first planner. For example, a pedestrian may move into a road after the first sensor data that is to be used by the first planner is obtained and subsequent to the second sensor data that is to be used by the second planner is obtained. Therefore, the first sensor data may not indicate presence of the pedestrian in the road while the second sensor data may indicate the presence of the pedestrian in the road. By using the second sensor data as compared to the first data, the second planner may be able to identify trajectories that are safer in the short term as compared to the trajectories generated by the first planner. In this manner, the second planner can validate the safety (e.g., the short term safety) of a trajectory generated by the first planner.

By using a combination of the first planner and the second planner, the plurality of trajectories generated for a plurality of planning steps can have smooth transitions while the trajectories can be adjusted based on updated sensor data such that the safety of the trajectories and the user experience is improved.

As discussed above, the first planner may generate and iteratively refine the plurality of trajectories across a plurality of planning steps. Further, the second planner may adjust the plurality of trajectories and select a trajectory for all or a portion of the planning steps. The first planner and the second planner may operate simultaneously such that the first planner refines the plurality of trajectories simultaneously with the second planner adjusting the plurality of trajectories and selecting a particular trajectory. For example, the first planner and the second planner can operate in parallel for selection of trajectories for all or a portion of the planning steps.

The first planner may generate the plurality of trajectories based on the sensor data and/or the location data. For example, the first planner may generate the plurality of trajectories based on a predicted environment of the vehicle based on the sensor data and/or the location data. As the first planner may maintain and/or reuse computations across planning steps, the first planner may be a stateful planner. In some cases, the first planner may select a trajectory from the plurality of trajectories.

The first planner may provide the plurality of trajectories and/or the selected trajectory to the second planner. Additionally, the second planner may obtain component data associated with the vehicle. Based on the component data, the second planner may adjust the plurality of trajectories and/or adjust the selected trajectory. As the second planner may adjust the plurality of trajectories and/or the selected trajectory based on the component data, the second planner may be a stateless planner. In some cases, the first planner may provide at least one alternative trajectory associated with the selected trajectory and the second planner may adjust the selected trajectory by replacing the selected trajectory with the alternative trajectory. In some cases, the second planner may select a trajectory from the adjusted plurality of trajectories. Therefore, the first planner may select a trajectory for the vehicle.

In some cases, the second planner may provide feedback to the first planner. The feedback may include a request to generate an adjusted plurality of trajectories. In response, the first planner may generate the adjusted plurality of trajectories and provide the adjusted plurality of trajectories to the second planner which may select a trajectory from the adjusted plurality of trajectories.

The planning system 404 can iteratively repeat the process of iteratively adjusting the plurality of trajectories and selecting trajectories from the iteratively adjusted plurality of trajectories for all or a portion of the planning steps. Based on the selected trajectories, the planning system 404 can define a path for the vehicle. The path can define a portion of a route for the vehicle from a first pose to a second pose (a first trajectory) to a third pose (a second trajectory) to a fourth pose (a third trajectory) . . . to a final pose (a final trajectory). In some cases, the planning system 404 can iteratively select a trajectory and instruct navigation according to the selected trajectory (e.g., based on sending the selected trajectory to a controller of the vehicle) prior to selecting a subsequent trajectory. The planning system 404 may select all or a portion of the trajectories from a plurality of trajectories that may be iteratively adjusted at all or a portion of the planning steps. Further, the plurality of trajectories generated prior to all or a portion of the planning steps may be iteratively adjusted according to the component data. Accordingly, the planning system 404 can generate a path without iteratively generating a plurality of trajectories for selection of a trajectory at each planning step.

The planning system 404 can define a route from a source to a destination based on the path. For example, the route can be based on multiple paths or trajectories.

The planning system 404 can utilize the path to train and/or test a control system of a vehicle. In some cases, the planning system 404 can provide a scene to a control system of a vehicle (e.g., in real time) and verify whether the vehicle navigates the scene according to the path.

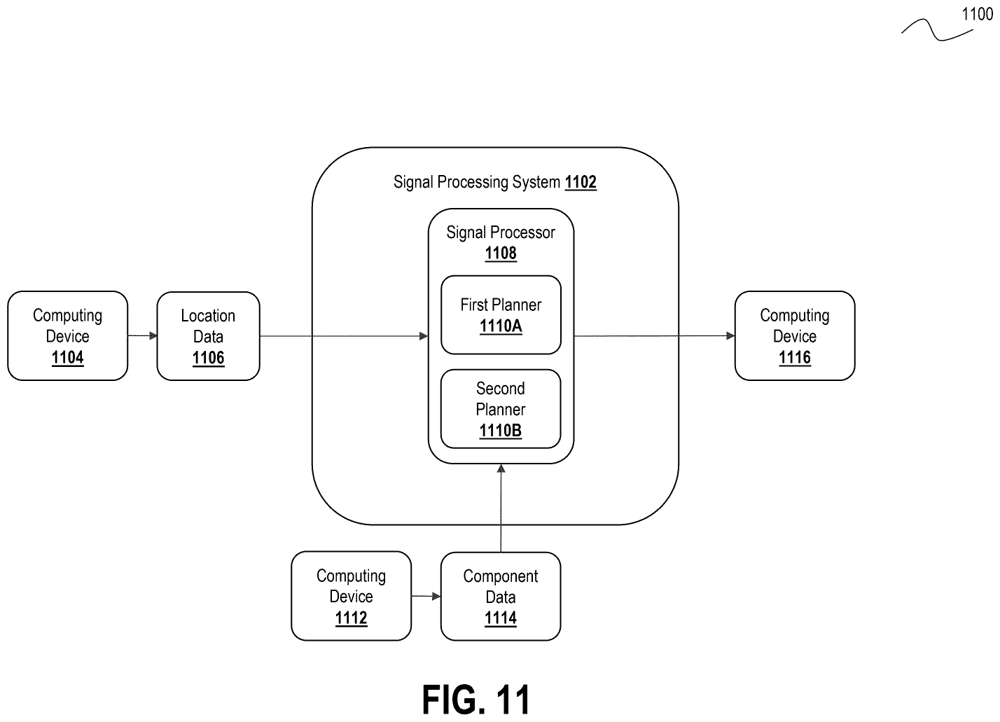

FIG. 11 is a block diagram illustrating an example of a signal processing environment 1100. In the illustrated example, the signal processing environment 1100 includes a signal processing system 1102 communicatively coupled with a computing device 1104, a computing device 1112, and a computing device 1116. All or a portion of computing device 1104, computing device 1112, and computing device 1116 can be the same as or similar to device 300 as described in FIG. 3. In some cases, the signal processing environment 1100 and/or the signal processing system 1102 can form at least a part of the planning system 404, described herein at least with reference to FIG. 4. The signal processing system 1102 can receive location data 1106 associated with the computing device 1104 and component data 1114 associated with the computing device 1112, and use the location data 1106 and the component data 1114 to identify a path for a vehicle.

The signal processing system 1102 (or another computing system) can initialize a path generation process. For example, the signal processing system 1102 can receive a request from a computing device (e.g., a user computing device) to navigate to a particular destination. In response, the signal processing system 1102 can initialize a path generation process to generate a path from a first pose to a second pose. In some cases, the signal processing system 1102 can generate a route for the vehicle from a source (e.g., a location of the vehicle) to the destination for the vehicle based on one or more paths. In another example, the signal processing system 1102 can receive a request to train or test a control system of the vehicle and, in response, initialize the path generation process.

The computing device 1104 provides location data 1106 associated with a location of a vehicle to the signal processing system 1102. In some cases, the signal processing system 1102 causes the computing device 1104 to provide the location data 1106 based on the initialization of the path generation process.

The computing device 1104 may be a computing device for generating training data (e.g., training location data that represents the location of a vehicle (physical or simulated) having an autonomous system installed thereon) and may provide the training data to the signal processing system 1102 to train and/or test a control system of a vehicle.

In some cases, the computing device 1104 may be in communication with a sensor. For example, the computing device 1104 may be in communication with (e.g., receive sensor data from) a location sensor (e.g., a global positioning sensor) associated with (e.g., located in, affixed to, etc.) a vehicle. In some embodiments, the computing device 1104 may be in communication with a plurality of sensors (e.g., a plurality of different location sensors) that each generate and/or provide location data to the signal processing system 1102. Similarly, the location data 1106 can include different types of location data, such as global positioning data associated with a vehicle. In some cases the computing device 1104 generates location data 1106 based on one or more settings (e.g., a time period). For example, the one or more settings may identify a time period for detection of the location data 1106. The location data 1106 may include streaming data and/or batch data.

The computing device 1112 provides component data 1114 associated with the vehicle to the signal processing system 1102. In some cases, the signal processing system 1102 causes the computing device 1112 to provide the component data 1114 based on the initialization of the path generation process. In some cases, the computing device 1112 may periodically or aperiodically provide the component data 1114 to the signal processing system 1102.

The computing device 1112 may be a computing device for generating training data (e.g., training component data that represents a vehicle having an autonomous system installed thereon, an environment, etc. (physical or simulated)) and may provide the component data to the signal processing system 1102 to train and/or test a control system of a vehicle.

In some cases, the computing device 1112 may be in communication with a sensor. For example, the computing device 1112 may be in communication with (e.g., receive sensor data from) a lidar sensor associated with (e.g., located in, affixed to, etc.) a vehicle, an image sensor associated with the vehicle, a radar sensor associated with the vehicle, a timer, etc. In some embodiments, the computing device 1112 may be in communication with a plurality of sensors (e.g., a plurality of different sensors) that each generate and/or provide component data to the signal processing system 1102. Similarly, the component data 1114 can include different types of component data, such as lidar data associated with the vehicle, image data associated with the vehicle, time data associated with the vehicle, etc. In some cases, the computing device 1112 generates component data 1114 based on one or more settings (e.g., a time period). For example, the one or more settings may identify a time period for detection of the component data 1114. The component data 1114 may include streaming data and/or batch data.

In the illustrated example, the signal processing system 1102 includes a signal processor 1108 to receive the location data 1106, however, it will be understood that the signal processing system 1102 can include fewer, more, or different components. The signal processor 1108 can process the location data 1106 and the component data 1114 to generate path data. In some cases, the signal processor 1108 processes the location data 1106 and the component data 1114 to generate path instructions for a control system of a vehicle.

The signal processor 1108 may include two or more planners. In the example of FIG. 11, the signal processor 1108 includes a first planner 1110A and a second planner 1110B. The first planner 1110A and the second planner 1110B may be the same or different planners and/or may execute the same or different planning processes, models, etc. For example, the first planner 1110A may implement a monte carlo tree search, imitation learning, etc. and the second planner 1110B may implement a learned scoring function, a handcrafted scoring function, machine learning, etc. In some cases, the first planner 1110A and/or the second planner 1110B may be a machine learning model (e.g., a neural network). For example, the first planner 1110A may be a recurrent neural network where a hidden state of the recurrent neural network is preserved across planning steps.

The signal processor 1108 may utilize the two or more planners to generate the path data. Specifically, the signal processor 1108 may use the first planner 1110A to generate a plurality of trajectories and may use the second planner 1110B to adjust the plurality of trajectories, select a particular trajectories, arbitrate between trajectories of the plurality of trajectories, provide feedback to the first planner 1110A, evaluate the plurality of trajectories, etc.

Based on the location data 1106 (e.g., a source and a destination for the vehicle), the signal processor 1108 can determine (e.g., generate) a plurality of trajectories (e.g., between the source and the destination). The plurality of trajectories may include a set of trajectories for each planning step of a plurality of planning steps. For example, the signal processor 1108 can determine a first set of trajectories between a first pose (e.g., a source) and a second set of poses, a second set of trajectories between the second set of poses and a third set of poses, . . . , an nth set of trajectories between a nth set of poses and an xth pose (e.g., a destination).

The signal processor 1108 may use the first planner 1110A to determine the plurality of trajectories. The first planner 1110A may determine the plurality of trajectories by building a tree of potential trajectories. For example, the first planner 1110A may perform a stochastic search to identify the plurality of trajectories. The first planner 1110A may maintain (e.g., persist) the plurality of trajectories across multiple planning steps and may update (e.g., refine) the plurality of trajectories across multiple planning steps (e.g., across the selection of multiple trajectories for multiple planning steps).

The plurality of trajectories may include a set of trajectories for all or a portion of the planning steps. For example, for all or a portion of the planning steps, the first planner 1110A may identify a set of trajectories. The first planner 1110A may identify the set of trajectories based on state data associated with the plurality of trajectories that is persisted across multiple planning steps. For example, the state data may indicate trajectories selected (e.g., previously) for the vehicle, paths selected for the vehicle, etc. Therefore, the first planner 1110 may refine the set of trajectories (e.g., continuously) based on the state data.

In some cases, the set of trajectories may include a trajectory selected by the first planner 1110A and/or one or more alternative trajectories for the particular planning step. For example, the set of trajectories may include a selected trajectory and multiple alternative trajectories selected by the first planner 1110A. In some cases, the set of trajectories may include a set of scored or ranked trajectories. For example, the first planner 1110A may score or rank each of the trajectories (e.g., a first trajectory may be ranked first, a second trajectory may be ranked second, a third trajectory may be ranked third, etc.) to indicate a selection of a trajectory and alternative trajectories (e.g., a trajectory ranked first may be a selected trajectory and a trajectory ranked second may be a first alternative trajectory). Each trajectory can be ranked and/or scored based on the priority of the violation, the number of violations, the type of violations, the magnitude of violations, etc.

In some cases, the set of trajectories may include a single trajectory. For example, the first planner 1110A may select a trajectory and remove other trajectories from the set of trajectories prior to providing the set of trajectories (e.g., the selected trajectory).

At each cycle, for a planning step (e.g., for each planning step), the signal processor 1108 can obtain the set of trajectories (e.g., a selected trajectory), adjust (e.g., update) the plurality of trajectories (e.g., the set of trajectories or a different set of trajectories for a different planning step), and select a trajectory. The signal processor 1108 may adjust the plurality of trajectories based on the component data 1114. For example, the signal processor 1108 may adjust the plurality of trajectories based on sensor data indicating a change in the environment (e.g., a pedestrian is located in front of the vehicle, another vehicle is braking in front of the vehicle, etc.), time data indicating a time period since generation of all or a portion of the plurality of trajectories, comparison data indicating a difference between first sensor data used to generate the plurality of trajectories and second sensor data associated with the environment (e.g., at the current planning step), etc.

The signal processor 1108 may use the second planner 1110B to adjust the plurality of trajectories. The second planner 1110B may obtain the set of trajectories from the first planner 1110A and may obtain component data 1114. Based on the component data, the second planner 1110B may adjust the plurality of trajectories. In some cases, the second planner 1110B may verify (e.g., validate) the set of trajectories (e.g., determine if the set of trajectories should be adjusted) and/or determine how to adjust the plurality of trajectories.

In some cases, the second planner 1110B may verify the set of trajectories by determining, based on the component data, a time period from generation of the plurality of trajectories and/or generation of the set of trajectories. For example, the second planner 1110B may determine that the plurality of trajectories were generated 30 seconds ago. The second planner 1110B may compare the time period to a threshold time period. If the time period exceeds and/or matches the threshold time period, the second planner 1110B may determine that the set of trajectories are to be adjusted.

In some cases, the second planner 1110B may verify the set of trajectories by determining, based on the component data, a time period between when the sensor data was obtained that is used to generate the plurality of trajectories and verification of the set of trajectories. For example, the second planner 1110B may determine that the plurality of trajectories were generated based on sensor data obtained 30 seconds ago. The second planner 1110B may compare the time period to a threshold time period. If the time period exceeds and/or matches the threshold time period, the second planner 1110B may determine that the set of trajectories are to be adjusted.

In some cases, the second planner 1110B may verify the set of trajectories by determining, based on the component data, any modifications to sensor data used to generate the plurality of trajectories and/or the set of trajectories. For example, the second planner 1110B may identify sensor data associated with the vehicle and compare the sensor data associated with the vehicle to the sensor data used to generate the plurality of trajectories. Further, the second planner 1110B may determine a difference level between the sensor data associated with the vehicle and the sensor data used to generate the plurality of trajectories. The second planner 1110B may compare the difference level to a threshold difference level. If the difference level exceeds and/or matches the threshold difference level, the second planner 1110B may determine that the set of trajectories are to be adjusted.

In some cases, the second planner 1110B may verify the set of trajectories by determining, based on the component data, whether sensor data associated with the vehicle includes particular sensor data. For example, the second planner 1110B may identify sensor data associated with the vehicle and determine whether the sensor data indicates presence of another vehicle, pedestrian, bicycle, etc. within a particular threshold proximity of the vehicle (e.g., 5 meters). If the sensor data includes particular sensor data, the second planner 1110B may determine that the set of trajectories are to be adjusted. For example, the second planner 1110B may determine that the set of trajectories are to be adjusted to include a trajectory corresponding to an immediate braking.

If the second planner 1110B determines that the set of trajectories are not to be adjusted (e.g., based on the component data), the second planner 1110B may identify path data indicative of a path for the vehicle based on the set of trajectories. For example, the second planner 1110B may identify path data based on a trajectory selected by the first planner 1110A. In some cases, to identify the path data, the second planner 1110B may select a trajectory from the set of trajectories. For example, the second planner 1110B may select a highest ranked trajectory as compared to other trajectories of the set of trajectories and as ranked by the first planner 1110A.

In some cases, if the second planner 1110B determines that the set of trajectories are to be adjusted (e.g., based on the component data), the second planner 1110B may adjust the set of trajectories by removing (e.g., pruning) one or more trajectories from the set of trajectories. For example, the second planner 1110B may remove trajectories from the set of trajectories based on the component data 1114 indicating that the trajectories were generated based on sensor data where a time period between obtaining the sensor data and verification of the set of trajectories exceeds and/or matches a threshold time period. In another example, the second planner 1110B may remove trajectories from the set of trajectories based on the component data 1114 indicating a change in a portion of the environment associated with the trajectories (e.g., indicating movement of a pedestrian to a location in the road).

In some cases, if the second planner 1110B determines that the set of trajectories are to be adjusted (e.g., based on the component data), the second planner 1110B may adjust the set of trajectories by adding one or more trajectories to the set of trajectories. For example, the second planner 1110B may add trajectories to the set of trajectories based on the component data 1114 indicating a change in a portion of the environment associated with the trajectories (e.g., indicating movement of a pedestrian from a location in the road).

In some cases, if the second planner 1110B determines that the set of trajectories are to be adjusted (e.g., based on the component data), the second planner 1110B may adjust the set of trajectories by modifying one or more trajectories from the set of trajectories. For example, the second planner 1110B may modify trajectories of the set of trajectories based on the component data 1114 indicating a change in a portion of the environment associated with the trajectories (e.g., indicating movement of a pedestrian from a location in the road).

In some cases, if the second planner 1110B determines that the set of trajectories are to be adjusted (e.g., based on the component data), the second planner 1110B may adjust the set of trajectories by generating an adjusted set of trajectories and/or by requesting generation of an adjusted set of trajectories by the first planner 1110A, etc.

The second planner 1110B may identify path data indicative of a path for the vehicle based on the adjusted set of trajectories. The second planner 1110B may identify path data based on a trajectory adjusted and selected by the second planner 1110B. For example, the second planner 1110B may adjust the set of trajectories by removing a highest ranked trajectory as compared to other trajectories of the set of trajectories and as ranked by the first planner 1110A from the set of trajectories and may select a next-highest ranked trajectory.

Based on generating the path data, the signal processor 1108 can determine that the path data should be routed to a computing device 1116. For example, the signal processor 1108 can determine that a control system of a vehicle should be tested or trained using the path data. In another example, the signal processor 1108 can determine that a control system of a vehicle (e.g., computing device 1116) should be instructed to cause navigation of the vehicle according to the path data. Accordingly, the signal processor 1108 can provide the path data to the computing device 1116.

### Example Trajectories for a Vehicle

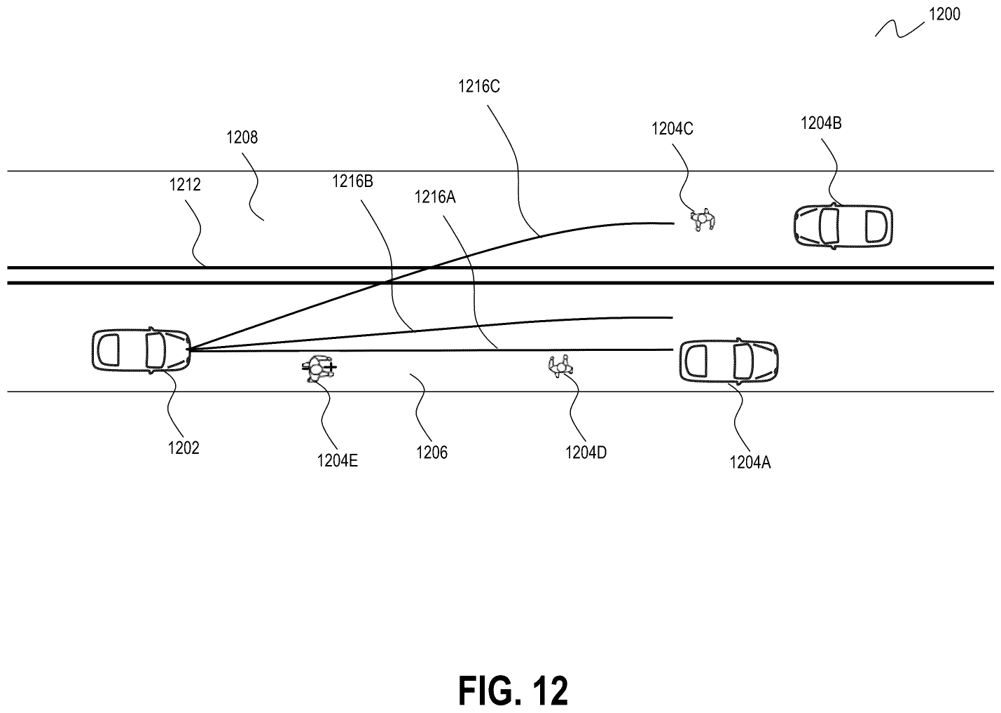

FIG. 12 is an example environment 1200 illustrating an example of a vehicle 1202 (e.g., a vehicle that is the same as, or similar to, vehicles 102 and/or vehicle 200) that is associated with an initial pose. The example environment 1200 may be based on one or more environmental parameters (e.g., 1206, 1208, 1212) and one or more objects (e.g., 1204A, 1204B, 1204C, 1204D). Each of the objects may have one or more object parameters (e.g., dynamic object parameters).

The vehicle 1202 can have an initial pose to identify an initial location, a starting location, etc. of the vehicle 1202. Based on the initial pose of the vehicle 1202 and a destination of the vehicle 1202, a system (e.g., the signal processing system 1102 of FIG. 11) can identify one or more trajectories for moving to a second pose from the initial pose. All or a portion of the one or more trajectories can identify a different trajectory from the initial pose to a different second pose. In some cases, the one or more trajectories may be defined by a user, via a user computing device. In some cases, the one or more trajectories may be defined by the system based on sensor data, test data, etc.

All or a portion of the combinations of a particular trajectory with a particular environment can result in a significantly different experience for the vehicle and a user of the vehicle (e.g., a different rule violation, a different speed, etc.). For example, a first trajectory can cause the vehicle to speed up, a second trajectory can cause the vehicle to slow down, a third trajectory can cause the vehicle to turn into oncoming traffic, and a fourth trajectory can cause the vehicle to turn into an off ramp. In another example, a first trajectory in a first scenario can cause the vehicle to violate a rule with a first priority (e.g., do not maneuver into a different lane) and the first trajectory in a second scenario can cause the vehicle to violate a rule with a second priority (e.g., do not exceed the speed limit) that is lower compared to the first priority.

As described herein, the signal processing system 1102 (using the first planner 1110A) can determine the set of trajectories from a plurality of trajectories for the vehicle and (using the second planner 1110B) can adjust the set of trajectories and/or the plurality of trajectories and select a particular trajectory from the set of trajectories. The signal processing system 1102 can dynamically adjust the set of trajectories and/or the plurality of trajectories based on component data. By dynamically adjusting the set of trajectories and/or the plurality of trajectories based on component data, the signal processing system 1102 can increase the likelihood that the selected trajectory causes a vehicle to violate a lower priority rule when a higher priority rule could be violated instead. Further, by dynamically adjusting the set of trajectories and/or the plurality of trajectories and not generating the set of trajectories and/or the plurality of trajectories at each cycle, the signal processing system 1102 decreases the computational requirements and increases the efficiency of the control system testing process and/or the navigation process. The signal processing system 1102 can, therefore, improve the accuracy, reliability, and efficiency of the vehicle 1202 and the control system testing process and/or the navigation process.

In the illustrated example of FIG. 12, the environment 1200 includes the vehicle 1202. The environment 1200 may be similar to the environment 100 as described above with reference to FIG. 1 and/or environment 600 as described above with reference to FIG. 6. The environment 1200 further includes a first object: vehicle 1204A, a second object: vehicle 1204B, a third object: pedestrian 1204C, a fourth object: pedestrian 1204D, and a fifth object: pedestrian 1204E. It will be understood that the example environment 1200 may include more, less, or different features, elements, characteristics, actors, etc. For example, the example environment 1200 may include additional vehicles, bicycles, pedestrians, etc.

The example environment 1200 can include one or more environmental parameters (e.g., geographical features). In the example of FIG. 12, the example environment 1200 includes a road that is divided into multiple lanes (lane 1206 and lane 1208). The lanes are divided by a double line 1212. The example environment 1200 may include more, less, or different geographical features and/or artificial features. For example, the example environment 1200 may include a plurality of light sources, a plurality of trees, a median, an off ramp, etc.

The one or more environmental parameters and the objects may be static parameters or dynamic parameters. For example, in some cases, the objects may not vary over a time period. In some cases, the objects may vary over a time period. For example, the pedestrian 1204E may be in the environment during a first time period and not in the environment during a second time period.

The objects may be based on one or more object parameters and corresponding object parameter values. The object parameters can include actions of the objects, the types of the objects, and/or the location of the objects. The object parameters may be static parameters or dynamic parameters that can vary over a time period. For example, in some cases, the object parameters may not vary over a time period. In some cases, the object parameters may vary over a time period. For example, the pedestrian 1204E may be walking in a first direction during a first time period and running in a second direction during a second time period.

In the example of FIG. 12, the vehicle 1202 is operating in lane 1206. The vehicle 1202 is positioned at an initial pose in the lane 1206. Similarly, vehicle 1204A is positioned in the lane 1206. The vehicle 1204A is stopped at a location within the lane 1206. For example, the vehicle 1204A may be stopped at a location within the lane 1206 due to a mechanical issue, the vehicle 1204A can be picking up or dropping off a passenger, etc. The flow of traffic in lane 1206 is opposite to the flow of traffic in lane 1208.

Vehicle 1204B is positioned in the lane 1208. The vehicle 1204B may be stopped at a location within the lane 1208 or may be moving in a direction opposite the direction of vehicle 1202 (e.g., with the flow of traffic in lane 1208). For example, the vehicle 1204B may be stopped at a location within the lane 1208 due to a mechanical issue, the vehicle 1204B can be picking up or dropping off a passenger, etc.

Pedestrians 1204C, 1204D, 1204E are positioned in the lanes 1206, 1208. The pedestrians 1204C, 1204D, 1204E may be stopped at a location within the lanes 1206, 1208 or may be crossing the lanes 1206, 1208. For example, all or a portion of the pedestrians 1204C, 1204D, 1204E may be moving from one side of the road to the other side of the road.

The example environment 1200 may be associated with a hierarchical plurality of rules. For example, the hierarchical plurality of rules can include rules for vehicles navigating within the example environment 1200. In the example of FIG. 12, the traffic rules in the environment 1200 prohibit a vehicle from crossing the double line 612, exceeding a predetermined speed limit (e.g., 45 miles per hour), approaching a stopped vehicle within a particular distance (e.g., within 5 meters), etc. in accordance with generally understood rules of the road.

In some cases, the vehicle 1202 may be navigating to a destination not described in FIG. 12. For example, the vehicle 1202 may be navigating to a particular destination on a different road.

The example environment 1200 may include more, less, or different objects. For example, the example environment 1200 may include more, less, or different objects that can block a trajectory of the vehicle 1202. Pedestrians, construction, cyclists, etc. can block a trajectory of the vehicle 1202. The vehicle 1202 can utilize a signal processing system (e.g., signal processing system 1102 as described in FIG. 11) to identify the objects and determine how to navigate the example environment 1200.

The signal processing system 1102 can identify a set of trajectories for the vehicle 1202 for a particular planning step. The signal processing system 1102 may generate the set of trajectories as part of generating a plurality of trajectories that includes multiple sets of trajectories corresponding to multiple planning steps. The set of trajectories for the vehicle 1202 can include driving into lane 1208 due to vehicle 1204A that is stopped in lane 1206, colliding with vehicle 1204A, maneuvering away from the vehicle 1204A but staying within the lane 1206, driving on a side of the road beside lane 1206, stopping, etc. A trajectory may be associated with a plurality of similar trajectories. For example, the set of trajectories can include multiple potential trajectories that involve driving into lane 1208. The multiple potential trajectories can include a different degree to which the vehicle 1202 enters the lane 1208, a different speed when driving in the lane 1208, a different time period for driving in the lane 1208, etc. Therefore, the set of trajectories can include multiple trajectories that are similar (e.g., multiple trajectories can exceed a threshold value (e.g., 75%) of similarity when compared).

In some cases, the signal processing system 1102 can utilize a first planner to generate the set of trajectories. The first planner may be a stateful planner that generates the set of trajectories based on state data associated with the vehicle 1202. For example, the first planner may generate the set of trajectories based on state data indicative of selected trajectories, selected paths, etc. In some cases, the first planner may select a particular trajectory of the set of trajectories.

In the example of FIG. 12, the signal processing system 1102 identifies the first trajectory 1216A, the second trajectory 1216B, and the third trajectory 1216C. Using the hierarchical plurality of rules, the signal processing system 1102 identifies that the first trajectory 1216A causes a violation of a first rule that prohibits collisions with another vehicle, the second trajectory 1216B causes a violation of a second rule that prohibits a vehicle from approaching a particular distance of another vehicle, and the third trajectory 1216C causes a violation of a third rule that prohibits a vehicle from entering a lane of traffic that is flowing in a direction that is oriented differently from a direction of the trajectory.

In some cases, based on determining a rule that each of the trajectories causes the vehicle 1202 to violate, the signal processing system 1102 can identify and select a trajectory that causes a violation of a lowest priority rule as compared to the priority of other rules that other trajectories of the set of trajectories cause to be violated. For example, the lowest priority rule that the trajectories cause the vehicle 1202 to violate may be a rule prohibiting approaching a particular distance of another vehicle (e.g., based on the second trajectory 1216B).

The signal processing system 1102 may obtain component data associated with the vehicle (e.g., sensor data associated with a sensor of the vehicle, time data associated with a timer, etc.). The signal processing system 1102 may dynamically adjust the set of trajectories based on the component data. For example, the signal processing system 1102 may dynamically adjust the set of trajectories by removing a trajectory, adding a trajectory, adjusting a trajectory, requesting generation of an adjusted set of trajectories, etc. The signal processing system 1102 may utilize a second planner to dynamically adjust the set of trajectories and select a trajectory for the vehicle 1202 from the adjusted set of trajectories.

In the example of FIG. 12, the signal processing system 1102 may adjust the set of trajectories by removing a particular trajectory. For example, the component data may indicate that pedestrian 1204D has moved further into lane 1206 (into the path corresponding to the second trajectory 1216B) and, based on the component data, the signal processing system 1102 may remove the second trajectory 1216B from the set of trajectories and select a trajectory from the adjusted set of trajectories (e.g., the third trajectory 1216C).

In some cases, the signal processing system 1102 may adjust the set of trajectories by adding a particular trajectory. For example, the component data may indicate that pedestrian 1204D has moved further into lane 1206 (into the path corresponding to the second trajectory 1216B) and, based on the component data, the signal processing system 1102 may add a trajectory to the set of trajectories that corresponds to a braking of the vehicle 1202 and select a trajectory from the adjusted set of trajectories (e.g., the added trajectory).

In some cases, the signal processing system 1102 may adjust the set of trajectories by adjusting a particular trajectory. For example, the component data may indicate that pedestrian 1204D has moved further into lane 1206 (into the path corresponding to the second trajectory 1216B) and, based on the component data, the signal processing system 1102 may adjust the second trajectory 1216B such that the second trajectory 1216B corresponds to a braking of the vehicle 1202 and select a trajectory from the adjusted set of trajectories (e.g., the adjusted second trajectory 1216B).

In some cases, the signal processing system 1102 may adjust the set of trajectories by generating an adjusted set of trajectories (e.g., by the first planner or the second planner). For example, the component data may indicate that pedestrian 1204D has moved further into lane 1206 (into the path corresponding to the second trajectory 1216B) and, based on the component data, the signal processing system 1102 may generate an adjusted set of trajectories (including additional trajectories) and select a trajectory from the adjusted set of trajectories (e.g., an additional trajectory). In some cases, based on adjusting the set of trajectories, the signal processing system 1102 may determine an update to a manner of generating the set of trajectories and may generate a further adjusted set of trajectories according to the update (e.g., subsequently to adjusting the set of trajectories).

Based on adjusting the set of trajectories, the signal processing system 1102 may select a trajectory for the vehicle 1202 (e.g., from the adjusted set of trajectories). The signal processing system 1102 may cause navigation of the vehicle 1202 based on a path corresponding to the selected trajectory.

### Example Operating Diagrams of a Signal Processor

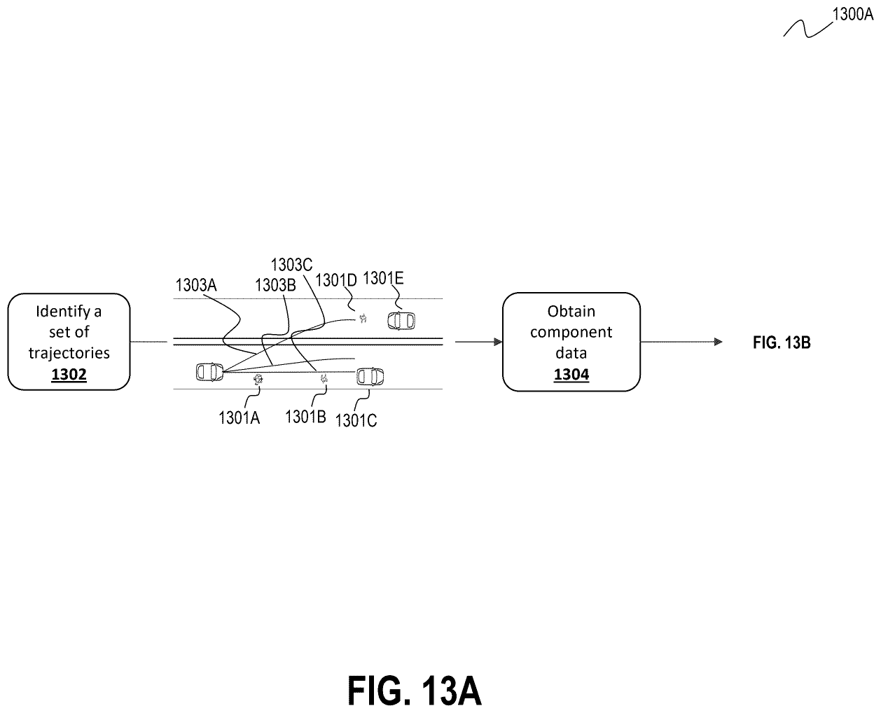

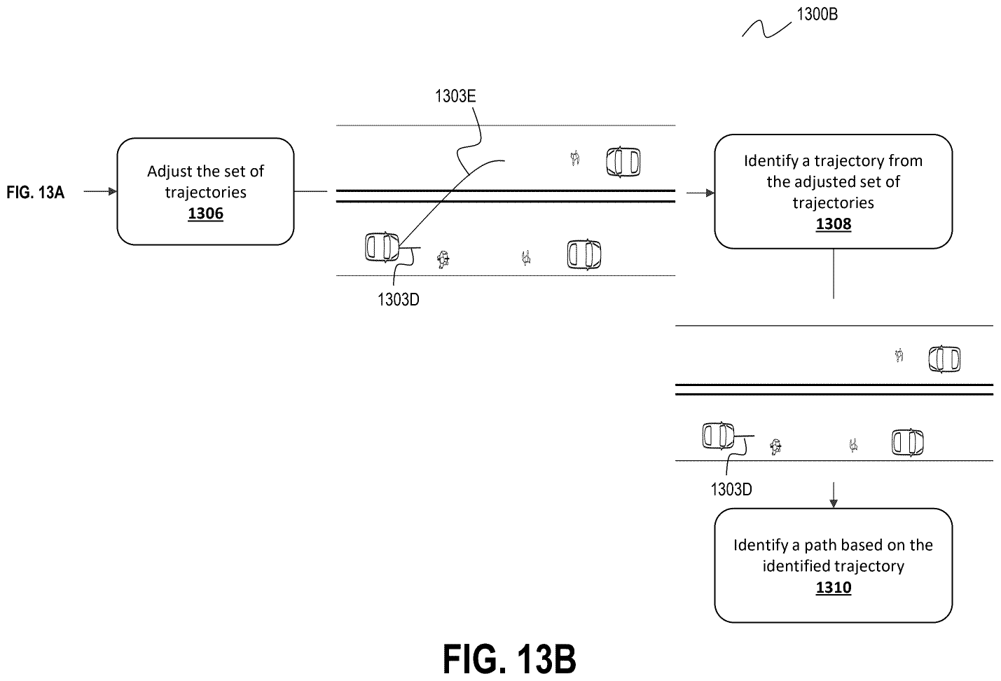

FIGS. 13A and 13B are operation diagrams illustrating a data flow for identifying a path for a vehicle. Specifically, FIGS. 13A and 13B are operation diagrams illustrating a data flow for identifying a set of potential trajectories for a vehicle during a planning step, dynamically adjusting the set of trajectories based on component data, and selecting a trajectory for the vehicle from the adjusted set of trajectories. Any component of the planning system 404 can facilitate the data flow for identifying a path for the vehicle based on the adjusted set of trajectories. In some embodiments, a different component can facilitate the data flow. In the example of FIG. 13A and FIG. 13B, a signal processing system (e.g., signal processing system 1102) facilitates the data flow.

At step 1302, the signal processing system 1102 identifies a set of trajectories 1303A, 1303B, and 1303C. The signal processing system 1102 identifies the set of trajectories 1303A, 1303B, and 1303C from a plurality of trajectories. To identify the set of trajectories 1303A, 1303B, and 1303C, the signal processing system 1102 can identify a plurality of trajectories that includes a set of trajectories for all or a portion of the planning steps of the path generation process. In some cases, the signal processing system 1102 can identify the set of trajectories 1303A, 1303B, and 1303C, from the plurality of trajectories, prior to, during, or after a planning step of a path generation process.

The signal processing system 1102 may generate the plurality of trajectories prior to a plurality of planning steps of the path generation process and may continuously refine and/or update the plurality of trajectories. Further, the signal processing system 1102 can refine the set of trajectories 1303A, 1303B, and 1303C based on trajectories selected in prior planning steps of the path generation process. In some cases, the signal processing system 1102 can automatically and/or continuously refine the set of trajectories.

The signal processing system 1102 may generate the plurality of trajectories based on sensor data indicative of environmental parameter(s) and/or object(s) in the environment. In the illustrated example, the environmental parameters indicate a two lane road with a marking between the two lanes. Further, the objects including pedestrians 1301A, 1301B, and 1301D and vehicles 1301C and 1301E.

The signal processing system 1102 identifies the set of trajectories 1303A, 1303B, and 1303C as a movement from an initial pose of the vehicle based on the sensor data. In some cases, the set of trajectories 1303A, 1303B, and 1303C may be defined as a series of intermediate poses between a first pose and a second pose.

In some cases, the signal processing system 1102 (or a separate system) can obtain input defining the set of trajectories 1303A, 1303B, and 1303C (e.g., a first pose and a second pose associated with a given movement of the vehicle). The signal processing system 1102 can cause a computing device to display a user interface that receives input defining the set of trajectories 1303A, 1303B, and 1303C. For example, the user interface can display a selection of trajectories for selection. In some cases, the user interface can receive written, audible, and/or image-based input defining the set of trajectories 1303A, 1303B, and 1303C.

At step 1304, the signal processing system 1102 obtains component data. The component data may be associated with the vehicle. For example, the component data may be sensor data associated with a plurality of sensors of the vehicle, time data associated with a timer of the vehicle, etc. In some cases, the sensor data may include camera data associated with a camera image, radar data associated with a radar image, LiDAR data associated with a lidar image, location data associated with a location sensor, acceleration data associated with an accelerometer, speed data associated with a speed sensor, rotation data associated with a gyroscope, position data associated with a position sensor, weather data associated with a weather sensor, traffic data associated with a traffic sensor, and/or any other sensor data. Further, the sensor(s) that capture the sensor data may include a camera image sensor, a LIDAR sensor, a radar sensor, a location sensor (e.g., a GPS sensor), an accelerometer, a speed sensor, a gyroscope, a position sensor, a weather sensor, a traffic data sensor, or any other sensors.

In one example, the component data may be indicative of a change in the environment of the vehicle (e.g., a movement of an object, a modification of a parameter of an object, an introduction of an additional object to the environment, a removal of an object from the environment, etc.), a period of time since generation of the set of trajectories 1303A, 1303B, and 1303C, and/or a period of time since obtaining senor data used to generate the set of trajectories 1303A, 1303B, and 1303C.

The signal processing system 1102 can identify one or more thresholds (e.g., threshold values, threshold ranges, etc.) associated with the component data. For example, the one or more thresholds may identify a threshold for determining when and/or how to adjust the set of trajectories 1303A, 1303B, and 1303C.

In some cases, the signal processing system 1102 (or a separate system) can obtain input defining the component data and/or the one or more thresholds. The signal processing system 1102 can cause a computing device to display a user interface that receives input defining the component data and/or the one or more thresholds. For example, the user interface can display different thresholds for selection. In some cases, the user interface can receive written, audible, and/or image-based input defining the component data and/or the one or more thresholds.

FIG. 13B is an operation diagram 1300B for adjusting the set of trajectories 1303A, 1303B, and 1303C based on the component data and identifying a path for the vehicle. The operation diagram 1300A may correspond to a first portion of a planning step and the operation diagram 1300B may correspond to a second, subsequent portion of the planning step. In some examples, the first step and the second step are separated by one or more intermediate steps.

At step 1306, the signal processing system 1102 adjusts the set of trajectories 1303A, 1303B, and 1303C. The signal processing system 1102 can adjust the set of trajectories 1303A, 1303B, and 1303C based on the component data. As discussed above, the signal processing system 1102 can adjust the set of trajectories 1303A, 1303B, and 1303C by removing one or more trajectories, adding one or more trajectories, modifying one or more trajectories, generating an adjusted set of trajectories, etc. In the example of FIG. 13A and FIG. 13B, the signal processing system 1102 adjusts the set of trajectories 1303A, 1303B, and 1303C by removing the trajectories 1303A, 1303B, and 1303C and adding trajectories 1303D and 1303E.

The signal processing system 1102 may remove the trajectories 1303A, 1303B, and 1303C and add the trajectories 1303D and 1303E based on processing the component data. The signal processing system 1102 may process the component data and determine one or more objects and/or one or more parameters of the one or more objects has changed based on a comparison of the component data to the sensor data used to generate the set of trajectories 1303A, 1303B, and 1303C. For example, the signal processing system 1102 may determine that an additional object (e.g., another vehicle) has entered the environment of the vehicle and may remove the trajectories 1303A, 1303B, and 1303C and add the trajectories 1303D and 1303E to avoid approaching a particular proximity of the additional object.

Further, the signal processing system 1102 may process the component data and determine a time period between generation of the set of trajectories and/or obtaining the sensor data used to generate the trajectories and obtaining the component data. For example, the signal processing system 1102 may determine that a time period between generation of the set of trajectories and obtaining the component data exceeds and/or matches a threshold time and may remove the trajectories 1303A, 1303B, and 1303C and add the trajectories 1303D and 1303E (which include braking) to avoid relying on sensor data and/or trajectories that may be outdated.

At step 1308, the signal processing system 1102 identifies a trajectory 1303D from the adjusted set of trajectories that violates a rule with the lowest priority. The signal processing system 1102 can identify rule data that identifies a plurality of hierarchical rules and a priority of all or a portion of the rules. Using the rule data, the signal processing system 1102 can identify, for all or a portion of the trajectories of the adjusted set of trajectories, a rule that the trajectory causes a vehicle to violate. The signal processing system 1102 can compare the priority of the rules violated by the adjusted set of trajectories. Based on comparing the priority of the rules violated by the adjusted set of trajectories, the signal processing system 1102 can identify a trajectory that causes a rule to be violated by the vehicle with a lowest priority as compared to other rules that other trajectories of the adjusted set of trajectories cause to be violated.

At step 1310, the signal processing system 1102 identifies a path based on the identified trajectory. The signal processing system 1102 can dynamically build a path that includes the identified trajectory.

The signal processing system 1102 can generate path data that identifies the path. Further, the signal processing system 1102 can route the path data to a computing device or a data store. In some cases, the signal processing system 1102 can route the path data to a control system of a vehicle for operation of the vehicle, and/or to a computing device for training and/or testing.

As described herein, the path generation process can be repeated thousands, hundreds of thousands, millions, or more times in order to generate paths for a vehicle (a path may include one or more trajectories). The signal processing system 1102 can combine one or more paths to form a trajectory for a vehicle. By dynamically adjusting the set of trajectories, the signal processing system 1102 can accurately and efficiently identify paths for a vehicle.

In addition, during the path generation process, some of the functions or elements described herein may not be used or may not be present. For example, during the path generation process, the signal processing system 1102 may not adjust the set of trajectories.

### Example Flow Diagram of a Signal Processor

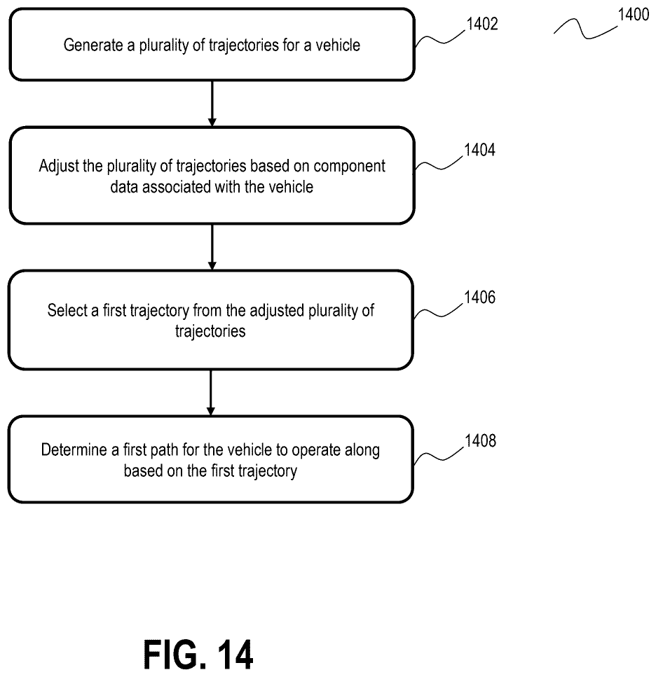

FIG. 14 is a flow diagram illustrating an example of a routine 1400 implemented by one or more processors (e.g., one or more processors of the signal processing system 1102). The flow diagram illustrated in FIG. 14 is provided for illustrative purposes only. It will be understood that one or more of the steps of the routine illustrated in FIG. 14 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 1402, the signal processing system 1102 generates a plurality of trajectories for a vehicle. The signal processing system 1102 may generate the plurality of trajectories based on a first trajectory associated with the vehicle. The plurality of trajectories may include multiple sets of trajectories. Different combinations of trajectories may represent different paths for the vehicle through the environment. Each set of trajectories may correspond to a particular planning step of a plurality of planning steps of the path generation process. In some cases, the signal processing system 1102 may generate the plurality of trajectories by generating all or a portion of the multiple sets of trajectories. Further, the signal processing system 1102 may generate the plurality of trajectories from a plurality of poses that are associated with different planning steps of the path generation process.

The plurality of trajectories may include a first set of trajectories from a particular pose. The pose may be a first pose (e.g., an initial pose) of a path for a vehicle. In some cases, the first pose is a pose located at an end of the first trajectory which may be maintained and selected during a prior planning step. The set of trajectories can represent operation of the vehicle from the first pose. The plurality of trajectories may include a second set of trajectories from at least one second pose located at an end of at least one trajectory of the first set of trajectories. It will be understood that the plurality of trajectories may include n iterative sets of trajectories, where n can be any number.

The signal processing system 1102 can receive rule data identifying a hierarchical plurality of rules. All or a portion of the hierarchical plurality of rules may have a priority with respect to all or a portion of the other rules of the hierarchical plurality of rules. For example, a rule may identify that the vehicle is to maintain a distance from a parked vehicle, the vehicle is to reach a destination, the vehicle is to stay in a lane, etc.

The set of trajectories can include a static set of trajectories, a dynamic set of trajectories, a sampled set of trajectories, or a set of trajectories based on a control method. For example, the signal processing system 1102 may periodically or continuously update the first set of trajectories.

In some cases, the signal processing system 1102 assigns a weight to all or a portion of the set of trajectories. For example, the signal processing system 1102 may assign a rule violation values to each trajectory. The weight may identify a risk associated with a particular trajectory and the given rule violation values.

In some cases, the signal processing system 1102 may utilize multiple planners. For example, the signal processing system 1102 may utilize a first planner (e.g., a stateful planner) and a second planner (e.g., a stateless planner). For example, the first planner may be a stateful planner that generates the plurality of trajectories based on state data associated with the plurality of trajectories, the state data indicative of a prior trajectory selected for the vehicle. Further, the second planner may be a stateless planner that adjusts the plurality of trajectories based on component data without regard to the state data. In one example, the first planner may implement (e.g., execute) a monte carlo tree search, imitation learning, etc. and the second planner may implement a learned scoring function, a handcrafted scoring function, or a machine learning model. The signal processing system 1102 may generate the plurality of trajectories using the first planner.

At block 1404, the signal processing system 1102 adjusts the plurality of trajectories based on component data associated with the vehicle. The signal processing system 1102 may obtain the component from one or more components (e.g., sensors, timers, etc.) associated with the vehicle, a driver, etc. For example, the component data may be sensor data associated with a plurality of sensors of the vehicle, time data associated with a timer of the vehicle, etc. As discussed above, the sensor data may include camera data associated with a camera image, radar data associated with a radar image, LiDAR data associated with a lidar image, location data associated with a location sensor, acceleration data associated with an accelerometer, speed data associated with a speed sensor, rotation data associated with a gyroscope, position data associated with a position sensor, weather data associated with a weather sensor, traffic data associated with a traffic sensor, and/or any other sensor data.

In some cases, to adjust the plurality of trajectories, the signal processing system 1102 may analyze the component data and determine a change in the environment of the vehicle relative to initial component data (e.g., initial sensor data) associated with the vehicle and used to generate the plurality of trajectories. For example, the signal processing system 1102 may generate the plurality of trajectories based on the initial component data, determine a change in the environment of the vehicle by comparing the initial component data and the component data, and adjust the plurality of trajectories based on the determined change in the environment. To determine the change in the environment, the signal processing system 1102 may analyze the component data and determine an object in the environment (e.g., a pedestrian, bicycle, another vehicle, etc.), movement and/or predicted movement of an object in the environment, etc. and compare the object, the movement of the object, the predicted movement of the object, etc. with an object identified in the initial component data used to generate the plurality of trajectories.

In some cases, to adjust the plurality of trajectories, the signal processing system 1102 may analyze the component data and determine a time period between generating of the plurality of trajectories, obtaining initial component data used to generate the plurality of trajectories, generating the initial component data, previously adjusting the plurality of trajectories, etc. and obtaining the component data, determining whether to adjust the plurality of trajectories, etc. For example, the signal processing system 1102 may determine a time period between generation of the plurality of trajectories and obtaining the component data, compare the time period to a threshold (e.g., a threshold period of time), and determine whether to and/or how to adjust the plurality of trajectories based on comparing the time period to the threshold. For example, the signal processing system 1102 may determine the time period exceeds and/or matches the threshold and may adjust the plurality of trajectories based on the determining the time period exceeds and/or matches the threshold.

The signal processing system 1102 may obtain an adjusted plurality of trajectories based on adjusting the plurality of trajectories. The signal processing stem may adjust the plurality of trajectories by adding a trajectory to the plurality of trajectories, removing a trajectory from the plurality of trajectories, adjusting a trajectory of the plurality of trajectories, generating an adjusted plurality of trajectories, etc. For example, the signal processing system 1102 may add a trajectory to the plurality of trajectories (e.g., the set of trajectories) to obtain the adjusted plurality of trajectories.

In some cases, the signal processing system 1102 may adjust the plurality of trajectories using the second planner. For example, the signal processing system 1102 may generate the plurality of trajectories using a first planner and may adjust the plurality of trajectories using a second planner.

At block 1406, the signal processing system 1102 selects a second trajectory from the adjusted plurality of trajectories. The second trajectory may be from a first pose to a second pose located at an end of the second trajectory. The signal processing system 1102 may select the second trajectory for a first planning step of the path generation process. In some cases, the second trajectory may be a trajectory adjusted or added to the plurality of trajectories based on the signal processing system 1102 adjusting the plurality of trajectories. In some cases, the second trajectory may be a trajectory that was not adjusted or added to the plurality of trajectories based on the signal processing system 1102 adjusting the plurality of trajectories.

The signal processing system 1102 may select the second trajectory based on a scoring, ranking, priority, etc. associated with the second trajectory. For example, the signal processing system 1102 may select the second trajectory based on a priority of a rule of which the second trajectory causes a violation.

As discussed above, in some cases, the signal processing system 1102 may select the second trajectory using the second planner. For example, the signal processing system 1102 may adjust the plurality of trajectories and may select the second trajectory using a second planner.

In some cases, the signal processing system 1102 may iteratively adjust the plurality of trajectories and select a trajectory for the vehicle (e.g., at each planning step). For example, the signal processing system 1102 may further adjust the adjusted plurality of trajectories (e.g., based on further component data associated with the vehicle) to obtain a further adjusted plurality of trajectories. The signal processing system 1102 may select a third trajectory from the further adjusted plurality of trajectories for a second planning step of the path generation process. In some cases, the signal processing system 1102 may not further adjust the adjusted plurality of trajectories (e.g., based on determining the adjusted plurality of trajectories should not be further adjusted) and may select the third trajectory from the adjusted plurality of trajectories. The third trajectory may be from a second pose located at the end of the second trajectory.

At block 1408, the signal processing system 1102 determines a first path for the vehicle to operate along based on the second trajectory. The path may include a sequence of trajectories from an initial pose to an end pose. The path may include the second trajectory and one or more additional trajectories. For example, as discussed above, the path may include the second trajectory and a third trajectory. The signal processing system 1102 can determine a route for the vehicle using the path. For example, the route may include one or more paths.

The signal processing system 1102 can route the path (or a route that includes the path) to a computing device. For example, the signal processing system 1102 can route the path to a computing device for testing and/or training, for navigation of a vehicle, etc. The signal processing system 1102 can transmit a message to the control system of the vehicle to operate (cause operation of the vehicle based on the path). In some cases, the signal processing system 1102 causes display of the path via a display of a computing device. For example, the signal processing system 1102 can cause display of a geographical map that identifies a location of the path. Further, the signal processing system 1102 can cause display of an indicator of the rules violated by the path. In some cases, the signal processing system 1102 generates a graph that identifies the path. The signal processing system 1102 can cause display of the graph.

In some cases, the signal processing system 1102 may iteratively adjust and select trajectories for planning steps (e.g., for n iterations, where n can be any number). For example, for each iteration, the signal processing system 1102 may iteratively adjust a previously adjusted plurality of trajectories to obtain an iteratively adjusted plurality of trajectories. The signal processing system 1102 may select a subsequent trajectory from the iteratively adjusted plurality of trajectories and add the subsequent trajectory to the path for the vehicle.

It will be understood that the routine 1400 can be repeated multiple times using different location data (e.g., different destinations, different initial poses, etc.) and/or different objects in an environment of the vehicle. In some cases, the signal processing system 1102 iteratively repeats the routine 1400 for multiple vehicles within the same environment. Further, the signal processing system 1102 can repeat the routine 1400 for the same vehicle during different time periods.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

Various additional example embodiments of the disclosure can be described by the following clauses:

Clause 1: A method comprising:
generating, using at least one processor, a plurality of trajectories for a vehicle from a plurality of poses based on a first trajectory associated with the vehicle, wherein combinations of trajectories of the plurality of trajectories represent a plurality of paths for the vehicle through an environment;
adjusting, using the at least one processor, the plurality of trajectories to obtain an adjusted plurality of trajectories based on component data associated with the vehicle;
selecting, using the at least one processor, a second trajectory from the adjusted plurality of trajectories; and
determining, using the at least one processor, a path for the vehicle to operate along based on the second trajectory.

Clause 2: The method of Clause 1, wherein generating the plurality of trajectories comprises:
generating a set of trajectories from a first pose, wherein the set of trajectories comprises the second trajectory, wherein the first pose is located at an end of the first trajectory.

Clause 3: The method of Clause 1 or Clause 2, wherein generating the plurality of trajectories comprises:
generating a first set of trajectories from a first pose; and
generating a second set of trajectories from at least one second pose, wherein the at least one second pose is located at an end of the first set of trajectories.

Clause 4: The method of any one of Clauses 1 through 3, wherein generating the plurality of trajectories comprises:
generating the plurality of trajectories based on initial component data associated with the vehicle,
wherein adjusting the plurality of trajectories comprises:
determining a change in the environment of the vehicle based on the component data; and
adjusting the plurality of trajectories based on determining the change in the environment of the vehicle.

Clause 5: The method of any one of Clauses 1 through 4, wherein adjusting the plurality of trajectories based on the component data comprises:
adjusting the plurality of trajectories based on at least one of:
a pedestrian,
a bicycle, or
another vehicle.

Clause 6: The method of any one of Clauses 1 through 5, wherein adjusting the plurality of trajectories comprises:
adding a third trajectory to the plurality of trajectories to generate the adjusted plurality of trajectories.

Clause 7: The method of any one of Clauses 1 through 6, wherein adjusting the plurality of trajectories comprises:
removing a third trajectory to the plurality of trajectories to generate the adjusted plurality of trajectories.

Clause 8: The method of any one of Clauses 1 through 7, wherein adjusting the plurality of trajectories comprises:
generating the adjusted plurality of trajectories based on updated component data associated with the vehicle.

Clause 9: The method of any one of Clauses 1 through 8, further comprising:
determining a period of time associated with the plurality of trajectories matches or exceeds a threshold period of time,
wherein adjusting the plurality of trajectories comprises:
adjusting the plurality of trajectories further based on determining the period of time matches or exceeds the threshold period of time.

Clause 10: The method of any one of Clauses 1 through 9, wherein generating the plurality of trajectories comprises:
generating the second trajectory from a first pose,
the method further comprising:
   selecting a third trajectory from the adjusted plurality of trajectories from a second pose, wherein the second pose is located at an end of the second trajectory,
wherein determining the path for the vehicle comprises:
   determining the path for the vehicle based on the second trajectory and the third trajectory.

Clause 11: The method of any one of Clauses 1 through 10, wherein generating the plurality of trajectories comprises:
generating the second trajectory from a first pose,
the method further comprising:
   adjusting the adjusted plurality of trajectories to obtain a further adjusted plurality of trajectories based on further component data associated with the vehicle;
   selecting a third trajectory from the further adjusted plurality of trajectories from a second pose, wherein the second pose is located at an end of the second trajectory,
wherein determining the path for the vehicle comprises:
   determining the path for the vehicle based on the second trajectory and the third trajectory.

Clause 12: The method of any one of Clauses 1 through 11, wherein generating the plurality of trajectories comprises:
generating the plurality of trajectories using a first planner,
wherein adjusting the plurality of trajectories comprises:
   adjusting the plurality of trajectories using a second planner.

Clause 13: The method of any one of Clauses 1 through 12, wherein generating the plurality of trajectories comprises:
generating the plurality of trajectories using a stateful planner based on state data associated with the plurality of trajectories and indicative of the first trajectory,
wherein adjusting the plurality of trajectories comprises:
   adjusting the plurality of trajectories using a stateless planner based on the component data.

Clause 14: The method of any one of Clauses 1 through 13, wherein generating the plurality of trajectories comprises:
generating the plurality of trajectories using a first planner executing at least one of a monte carlo tree search or imitation learning,
wherein adjusting the plurality of trajectories comprises:
   adjusting the plurality of trajectories using a second planner executing at least one of a learned scoring function, a handcrafted scoring function, or machine learning.

Clause 15: The method of any one of Clauses 1 through 14, further comprising: transmitting a message to a control system of the vehicle to operate the vehicle based on the path for the vehicle.

Clause 16: The method of any one of Clauses 1 through 15, further comprising: generating a graph, wherein the graph identifies the path for the vehicle.

Clause 17: The method of any one of Clauses 1 through 16, further comprising, for n iterations:
iteratively adjusting the adjusted plurality of trajectories to obtain an iteratively adjusted plurality of trajectories;
selecting a subsequent trajectory from the iteratively adjusted plurality of trajectories; and
adding the subsequent trajectory to the path for the vehicle,
wherein n can be any number.

Clause 18: The method of any one of Clauses 1 through 17, wherein adjusting the plurality of trajectories comprises:
adjusting the plurality of trajectories based on component data associated with at least one of:
   a lidar sensor;
   a radar sensor;
   an image sensor; or
   a timer.

Clause 19: A system comprising:
at least one processor, and
at least one non-transitory storage media storing instructions that, when executed by the at least one processor, cause the at least one processor to:
   generate a plurality of trajectories for a vehicle from a plurality of poses based on a first trajectory associated with the vehicle, wherein combinations of trajectories of the plurality of trajectories represent a plurality of paths for the vehicle through an environment;
   adjust the plurality of trajectories to obtain an adjusted plurality of trajectories based on component data associated with the vehicle;
   select a second trajectory from the adjusted plurality of trajectories; and
   determine a path for the vehicle to operate along based on the second trajectory.

Clause 20: At least one non-transitory storage media storing instructions that, when executed by a computing system comprising a processor, cause the computing system to:
generate a plurality of trajectories for a vehicle from a plurality of poses based on a first trajectory associated with the vehicle, wherein combinations of trajectories of the plurality of trajectories represent a plurality of paths for the vehicle through an environment;
adjust the plurality of trajectories to obtain an adjusted plurality of trajectories based on component data associated with the vehicle;
select a second trajectory from the adjusted plurality of trajectories; and
determine a path for the vehicle to operate along based on the second trajectory.

Clause 21: The system of Clause 19, wherein to generate the plurality of trajectories execution of the instructions further causes the at least one processor to:
generate a set of trajectories from a first pose, wherein the set of trajectories comprises the second trajectory, wherein the first pose is located at an end of the first trajectory.

Clause 22: The system of Clause 19 or Clause 21, wherein to generate the plurality of trajectories execution of the instructions further causes the at least one processor to:
generate a first set of trajectories from a first pose; and
generate a second set of trajectories from at least one second pose, wherein the at least one second pose is located at an end of the first set of trajectories.

Clause 23: The system of any one of Clause 19, Clause 21, or Clause 22, wherein to generate the plurality of trajectories execution of the instructions further causes the at least one processor to:
generate the plurality of trajectories based on initial component data associated with the vehicle,
wherein to adjust the plurality of trajectories execution of the instructions further causes the at least one processor to:
   determine a change in the environment of the vehicle based on the component data; and
   adjust the plurality of trajectories based on determining the change in the environment of the vehicle.

Clause 24: The system of any one of Clause 19 or Clauses 21 through 23, wherein to adjust the plurality of trajectories execution of the instructions further causes the at least one processor to:
adjust the plurality of trajectories based on at least one of:
   a pedestrian,
   a bicycle, or
   another vehicle.

Clause 25: The system of any one of Clause 19 or Clauses 21 through 24, wherein to adjust the plurality of trajectories execution of the instructions further causes the at least one processor to:
add a third trajectory to the plurality of trajectories to generate the adjusted plurality of trajectories.

Clause 26: The system of any one of Clause 19 or Clauses 21 through 25, wherein to adjust the plurality of trajectories execution of the instructions further causes the at least one processor to:
remove a third trajectory to the plurality of trajectories to generate the adjusted plurality of trajectories.

Clause 27: The system of any one of Clause 19 or Clauses 21 through 26, wherein to adjust the plurality of trajectories execution of the instructions further causes the at least one processor to:
generate the adjusted plurality of trajectories based on updated component data associated with the vehicle.

Clause 28: The system of any one of Clause 19 or Clauses 21 through 27, wherein execution of the instructions further causes the at least one processor to:
determine a period of time associated with the plurality of trajectories matches or exceeds a threshold period of time,
wherein to adjust the plurality of trajectories execution of the instructions further causes the at least one processor to:
   adjust the plurality of trajectories further based on determining the period of time matches or exceeds the threshold period of time.

Clause 29: The system of any one of Clause 19 or Clauses 21 through 28, wherein to generate the plurality of trajectories execution of the instructions further causes the at least one processor to:
generate the second trajectory from a first pose,
wherein execution of the instructions further causes the at least one processor to:
select a third trajectory from the adjusted plurality of trajectories from a second pose, wherein the second pose is located at an end of the second trajectory,
wherein to determine the path for the vehicle execution of the instructions further causes the at least one processor to:
   determine the path for the vehicle based on the second trajectory and the third trajectory.

Clause 30: The system of any one of Clause 19 or Clauses 21 through 29, wherein to generate the plurality of trajectories execution of the instructions further causes the at least one processor to:
generate the second trajectory from a first pose,
wherein execution of the instructions further causes the at least one processor to:
adjust the adjusted plurality of trajectories to obtain a further adjusted plurality of trajectories based on further component data associated with the vehicle;
select a third trajectory from the further adjusted plurality of trajectories from a second pose, wherein the second pose is located at an end of the second trajectory,
wherein to determine the path for the vehicle execution of the instructions further causes the at least one processor to:
   determine the path for the vehicle based on the second trajectory and the third trajectory.

Clause 31: The system of any one of Clause 19 or Clauses 21 through 30, wherein to generate the plurality of trajectories execution of the instructions further causes the at least one processor to:
generate the plurality of trajectories using a first planner,
wherein to adjust the plurality of trajectories execution of the instructions further causes the at least one processor to:
   adjust the plurality of trajectories using a second planner.

Clause 32: The system of any one of Clause 19 or Clauses 21 through 31, wherein to generate the plurality of trajectories execution of the instructions further causes the at least one processor to:
generate the plurality of trajectories using a stateful planner based on state data associated with the plurality of trajectories and indicative of the first trajectory,
wherein to adjust the plurality of trajectories execution of the instructions further causes the at least one processor to:
   adjust the plurality of trajectories using a stateless planner based on the component data.

Clause 33: The system of any one of Clause 19 or Clauses 21 through 32, wherein to generate the plurality of trajectories execution of the instructions further causes the at least one processor to:
generate the plurality of trajectories using a first planner executing at least one of a monte carlo tree search or imitation learning,
wherein to adjust the plurality of trajectories execution of the instructions further causes the at least one processor to:
   adjust the plurality of trajectories using a second planner executing at least one of a learned scoring function, a handcrafted scoring function, or machine learning.

Clause 34: The system of any one of Clause 19 or Clauses 21 through 33, wherein execution of the instructions further causes the at least one processor to:
transmit a message to a control system of the vehicle to operate the vehicle based on the path for the vehicle.

Clause 35: The system of any one of Clause 19 or Clauses 21 through 34, wherein execution of the instructions further causes the at least one processor to:
generate a graph, wherein the graph identifies the path for the vehicle.

Clause 36: The system of any one of Clause 19 or Clauses 21 through 35, wherein execution of the instructions further causes the at least one processor to, for n iterations:
iteratively adjust the adjusted plurality of trajectories to obtain an iteratively adjusted plurality of trajectories;
select a subsequent trajectory from the iteratively adjusted plurality of trajectories; and
add the subsequent trajectory to the path for the vehicle,
wherein n can be any number.

Clause 37: The system of any one of Clause 19 or Clauses 21 through 36, wherein to adjust the plurality of trajectories execution of the instructions further causes the at least one processor to:
adjust the plurality of trajectories based on component data associated with at least one of:
   a lidar sensor;
   a radar sensor;
   an image sensor; or
   a timer.

Clause 38: The at least one non-transitory storage media of Clause 20, wherein to generate the plurality of trajectories execution of the instructions further causes the computing system to:
generate a set of trajectories from a first pose, wherein the set of trajectories comprises the second trajectory, wherein the first pose is located at an end of the first trajectory.

Clause 39: The at least one non-transitory storage media of Clause 20 or Clause 38, wherein to generate the plurality of trajectories execution of the instructions further causes the computing system to:
generate a first set of trajectories from a first pose; and
generate a second set of trajectories from at least one second pose, wherein the at least one second pose is located at an end of the first set of trajectories.

Clause 40: The at least one non-transitory storage media of Clause 20, Clause 38, or Clause 39, wherein to generate the plurality of trajectories execution of the instructions further causes the computing system to:
generate the plurality of trajectories based on initial component data associated with the vehicle,
wherein to adjust the plurality of trajectories execution of the instructions further causes the computing system to:
   determine a change in the environment of the vehicle based on the component data; and
   adjust the plurality of trajectories based on determining the change in the environment of the vehicle.

Clause 41: The at least one non-transitory storage media of any one of Clause 20 or Clauses 38 through 40, wherein to adjust the plurality of trajectories execution of the instructions further causes the computing system to:
adjust the plurality of trajectories based on at least one of:
   a pedestrian,
   a bicycle, or
   another vehicle.

Clause 42: The at least one non-transitory storage media of any one of Clause 20 or Clauses 38 through 41, wherein to adjust the plurality of trajectories execution of the instructions further causes the computing system to:
add a third trajectory to the plurality of trajectories to generate the adjusted plurality of trajectories.

Clause 43: The at least one non-transitory storage media of any one of Clause 20 or Clauses 38 through 42, wherein to adjust the plurality of trajectories execution of the instructions further causes the computing system to:
remove a third trajectory to the plurality of trajectories to generate the adjusted plurality of trajectories.

Clause 44: The at least one non-transitory storage media of any one of Clause 20 or Clauses 38 through 43, wherein to adjust the plurality of trajectories execution of the instructions further causes the computing system to:
generate the adjusted plurality of trajectories based on updated component data associated with the vehicle.

Clause 45: The at least one non-transitory storage media of any one of Clause 20 or Clauses 38 through 44, wherein execution of the instructions further causes the computing system to:
determine a period of time associated with the plurality of trajectories matches or exceeds a threshold period of time,
wherein to adjust the plurality of trajectories execution of the instructions further causes the computing system to:
   adjust the plurality of trajectories further based on determining the period of time matches or exceeds the threshold period of time.

Clause 46: The at least one non-transitory storage media of any one of Clause 20 or Clauses 38 through 45, wherein to generate the plurality of trajectories execution of the instructions further causes the computing system to:
generate the second trajectory from a first pose,
wherein execution of the instructions further causes the computing system to:
   select a third trajectory from the adjusted plurality of trajectories from a second pose, wherein the second pose is located at an end of the second trajectory,
wherein to determine the path for the vehicle execution of the instructions further causes the computing system to:
   determine the path for the vehicle based on the second trajectory and the third trajectory.

Clause 47: The at least one non-transitory storage media of any one of Clause 20 or Clauses 38 through 46, wherein to generate the plurality of trajectories execution of the instructions further causes the computing system to:
generate the second trajectory from a first pose,
wherein execution of the instructions further causes the computing system to:
   adjust the adjusted plurality of trajectories to obtain a further adjusted plurality of trajectories based on further component data associated with the vehicle;
   select a third trajectory from the further adjusted plurality of trajectories from a second pose, wherein the second pose is located at an end of the second trajectory,
wherein to determine the path for the vehicle execution of the instructions further causes the computing system to:
   determine the path for the vehicle based on the second trajectory and the third trajectory.

Clause 48: The at least one non-transitory storage media of any one of Clause 20 or Clauses 38 through 47, wherein to generate the plurality of trajectories execution of the instructions further causes the computing system to:
generate the plurality of trajectories using a first planner,
wherein to adjust the plurality of trajectories execution of the instructions further causes the computing system to:
   adjust the plurality of trajectories using a second planner.

Clause 49: The at least one non-transitory storage media of any one of Clause 20 or Clauses 38 through 48, wherein to generate the plurality of trajectories execution of the instructions further causes the computing system to:
generate the plurality of trajectories using a stateful planner based on state data associated with the plurality of trajectories and indicative of the first trajectory,
wherein to adjust the plurality of trajectories execution of the instructions further causes the computing system to:
   adjust the plurality of trajectories using a stateless planner based on the component data.

Clause 50: The at least one non-transitory storage media of any one of Clause 20 or Clauses 38 through 49, wherein to generate the plurality of trajectories execution of the instructions further causes the computing system to:
generate the plurality of trajectories using a first planner executing at least one of a monte carlo tree search or imitation learning,
wherein to adjust the plurality of trajectories execution of the instructions further causes the computing system to:
   adjust the plurality of trajectories using a second planner executing at least one of a learned scoring function, a handcrafted scoring function, or machine learning.

Clause 51: The at least one non-transitory storage media of any one of Clause 20 or Clauses 38 through 50, wherein execution of the instructions further causes the computing system to:
transmit a message to a control system of the vehicle to operate the vehicle based on the path for the vehicle.

Clause 52: The at least one non-transitory storage media of any one of Clause 20 or Clauses 38 through 51, wherein execution of the instructions further causes the computing system to:
generate a graph, wherein the graph identifies the path for the vehicle.

Clause 53: The at least one non-transitory storage media of any one of Clause 20 or Clauses 38 through 52, wherein execution of the instructions further causes the computing system to, for n iterations:
iteratively adjust the adjusted plurality of trajectories to obtain an iteratively adjusted plurality of trajectories;
select a subsequent trajectory from the iteratively adjusted plurality of trajectories; and
add the subsequent trajectory to the path for the vehicle,
wherein n can be any number.

Clause 54: The at least one non-transitory storage media of any one of Clause 20 or Clauses 38 through 53, wherein to adjust the plurality of trajectories execution of the instructions further causes the computing system to:
adjust the plurality of trajectories based on component data associated with at least one of:
   a lidar sensor;
   a radar sensor;
   an image sensor; or
   a timer.

1. A method comprising:
generating, using at least one processor, a plurality of trajectories for a vehicle from a plurality of poses based on a first trajectory associated with the vehicle, wherein combinations of trajectories of the plurality of trajectories represent a plurality of paths for the vehicle through an environment;
adjusting, using the at least one processor, the plurality of trajectories to obtain an adjusted plurality of trajectories based on component data associated with the vehicle;
selecting, using the at least one processor, a second trajectory from the adjusted plurality of trajectories; and
determining, using the at least one processor, a path for the vehicle to operate along based on the second trajectory.

2. The method of claim 1, wherein generating the plurality of trajectories comprises:
generating a set of trajectories from a first pose, wherein the set of trajectories comprises the second trajectory, wherein the first pose is located at an end of the first trajectory.

3. The method of claim 1, wherein generating the plurality of trajectories comprises:
generating a first set of trajectories from a first pose; and
generating a second set of trajectories from at least one second pose, wherein the at least one second pose is located at an end of the first set of trajectories.

4. The method of claim 1, wherein generating the plurality of trajectories comprises:
generating the plurality of trajectories based on initial component data associated with the vehicle,
wherein adjusting the plurality of trajectories comprises:
determining a change in the environment of the vehicle based on the component data; and
adjusting the plurality of trajectories based on determining the change in the environment of the vehicle.

5. The method of claim 1, wherein adjusting the plurality of trajectories based on the component data comprises:
adjusting the plurality of trajectories based on at least one of:
a pedestrian,
a bicycle, or
another vehicle.

6. The method of claim 1, wherein adjusting the plurality of trajectories comprises:
adding a third trajectory to the plurality of trajectories to generate the adjusted plurality of trajectories.

7. The method of claim 1, wherein adjusting the plurality of trajectories comprises:
removing a third trajectory to the plurality of trajectories to generate the adjusted plurality of trajectories.

8. The method of claim 1, wherein adjusting the plurality of trajectories comprises:
generating the adjusted plurality of trajectories based on updated component data associated with the vehicle.

9. The method of claim 1, further comprising:
determining a period of time associated with the plurality of trajectories matches or exceeds a threshold period of time,
wherein adjusting the plurality of trajectories comprises:
adjusting the plurality of trajectories further based on determining the period of time matches or exceeds the threshold period of time.

10. The method of claim 1, wherein generating the plurality of trajectories comprises:
generating the second trajectory from a first pose,
the method further comprising:
selecting a third trajectory from the adjusted plurality of trajectories from a second pose, wherein the second pose is located at an end of the second trajectory,
wherein determining the path for the vehicle comprises:
determining the path for the vehicle based on the second trajectory and the third trajectory.

11. The method of claim 1, wherein generating the plurality of trajectories comprises:
generating the second trajectory from a first pose,
the method further comprising:
adjusting the adjusted plurality of trajectories to obtain a further adjusted plurality of trajectories based on further component data associated with the vehicle;
selecting a third trajectory from the further adjusted plurality of trajectories from a second pose, wherein the second pose is located at an end of the second trajectory,
wherein determining the path for the vehicle comprises:
determining the path for the vehicle based on the second trajectory and the third trajectory.

12. The method of claim 1, wherein generating the plurality of trajectories comprises:
generating the plurality of trajectories using a first planner,
wherein adjusting the plurality of trajectories comprises:
adjusting the plurality of trajectories using a second planner.

13. The method of claim 1, wherein generating the plurality of trajectories comprises:
generating the plurality of trajectories using a stateful planner based on state data associated with the plurality of trajectories and indicative of the first trajectory,
wherein adjusting the plurality of trajectories comprises:
adjusting the plurality of trajectories using a stateless planner based on the component data.

14. The method of claim 1, wherein generating the plurality of trajectories comprises:
generating the plurality of trajectories using a first planner executing at least one of a monte carlo tree search or imitation learning,
wherein adjusting the plurality of trajectories comprises:
adjusting the plurality of trajectories using a second planner executing at least one of a learned scoring function, a handcrafted scoring function, or machine learning.

15. The method of claim 1, further comprising:
transmitting a message to a control system of the vehicle to operate the vehicle based on the path for the vehicle.

16. The method of claim 1, further comprising:
generating a graph, wherein the graph identifies the path for the vehicle.

17. The method of claim 1, further comprising, for n iterations:
iteratively adjusting the adjusted plurality of trajectories to obtain an iteratively adjusted plurality of trajectories;
selecting a subsequent trajectory from the iteratively adjusted plurality of trajectories; and
adding the subsequent trajectory to the path for the vehicle,
wherein n can be any number.

18. The method of claim 1, wherein adjusting the plurality of trajectories comprises:
adjusting the plurality of trajectories based on component data associated with at least one of:
a lidar sensor;
a radar sensor;
an image sensor; or
a timer.

19. A system comprising:
at least one processor, and
at least one non-transitory storage media storing instructions that, when executed by the at least one processor, cause the at least one processor to:
generate a plurality of trajectories for a vehicle from a plurality of poses based on a first trajectory associated with the vehicle, wherein combinations of trajectories of the plurality of trajectories represent a plurality of paths for the vehicle through an environment;
adjust the plurality of trajectories to obtain an adjusted plurality of trajectories based on component data associated with the vehicle;
select a second trajectory from the adjusted plurality of trajectories; and
determine a path for the vehicle to operate along based on the second trajectory.

20. At least one non-transitory storage media storing instructions that, when executed by a computing system comprising a processor, cause the computing system to:
generate a plurality of trajectories for a vehicle from a plurality of poses based on a first trajectory associated with the vehicle, wherein combinations of trajectories of the plurality of trajectories represent a plurality of paths for the vehicle through an environment;
adjust the plurality of trajectories to obtain an adjusted plurality of trajectories based on component data associated with the vehicle;
select a second trajectory from the adjusted plurality of trajectories; and
determine a path for the vehicle to operate along based on the second trajectory.
